(19) United States
(12) Patent Application Publication
(10) Pub. No.: US 2014/0072055 A1
(43) Pub. Date: Mar. 13, 2014

(54) IMAGE PROCESSING APPARATUS AND IMAGE PROCESSING METHOD

(71) Applicant: Sony Corporation, Tokyo (JP)

(72) Inventor: Kazushi Sato, Kanagawa (JP)

(73) Assignee: Sony Corporation, Tokyo (JP)

(21) Appl. No.: 14/114,932

(22) PCT Filed: Jun. 6, 2012
(86) PCT No.: PCT/JP2012/064537

§ 371 Date: Oct. 31, 2013

(30) Foreign Application Priority Data
Jun. 14, 2011 (JP) 2011132019

(51) Int. Cl. H04N 7/36

(52) U.S. Cl. CPC H04N 19/00709
USPC 375/240.16

(57) ABSTRACT

The present technique relates to an image processing apparatus and an image processing method which allow the encoding efficiency to be improved. A temporal predictive motion vector information determination unit determines, in performing motion prediction on an image, an extraction region from which motion vector information is extracted as temporal predictive motion vector information from within a reference region in a reference image, the reference region corresponding to a current region to be processed. A differential motion vector generation part generates differential motion information that is a difference between the temporal predictive motion vector information extracted from the extraction region being determined and motion information of the current region. The reference region is partitioned into a plurality of divided regions, so that the temporal predictive motion vector information determination unit determines the largest region having the largest area of overlap with the current region as the extraction region from among the plurality of divided regions within the reference region. The present technique can be applied to an image processing apparatus.

### TECHNICAL FIELD

The present technique relates to an image processing apparatus and an image processing method, particularly to an image processing apparatus and an image processing method by which efficiency of encoding a motion vector can be improved.

### BACKGROUND ART

In recent years, an apparatus conforming to an MPEG (Moving Picture Experts Group) scheme and the like is becoming widespread in both broadcast stations which distribute information and ordinary households which receive information, where the MPEG scheme treats image information as digital and compresses the information, for the purpose of efficiently transmitting and storing information, by means of an orthogonal transform such as a discrete cosine transform and motion compensation while exploiting redundancy specific to the image information.

MPEG-2 (ISO (International Organization for Standardization)/IEC (International Electrotechnical Commission) 13818-2), in particular, is defined as a general-purpose image encoding scheme that is a standard covering both an interlaced scan image and a progressive scan image as well as images with a standard resolution and a high resolution. The MPEG-2 is now used widely in a wide range of applications for use by professionals and consumers. The use of the MPEG-2 compression scheme can realize a high compression ratio and satisfactory image quality by assigning a code amount (hit rate) of 4 to 8 Mbps to an interlaced scan image with a standard resolution having 720×480 pixels, or 18 to 22 Mbps to an interlaced scan image with a high resolution having 1920×1088 pixels, for example.

The MPEG-2 has targeted high image-quality encoding adapted mainly for broadcasting, but has not been suited for an encoding scheme with a code amount (bit rate) lower than that of MPEG-1, namely, an encoding scheme with a higher compression ratio. The need for such encoding scheme is expected to increase in the future as a mobile terminal is coming into wide use. In response, an MPEG-4 encoding scheme has been standardized. With regards to the image encoding scheme, the standard was approved as an international standard ISO/IEC 14496-2 in December, 1998.

Furthermore, a standard named H.26L (ITU-T (International Telecommunication Union Telecommunication Standardization Sector) Q6/16 VCEG (Video Coding Expert Group)), which is initially intended for encoding an image used in a television conference, has been in the process of becoming standardized in recent years. While requiring a greater amount of calculation in encoding and decoding compared to the conventional encoding schemes such as the MPEG-2 and the MPEG-4, the H.26L is known to achieve higher encoding efficiency. As a part of the actions pertaining to the MPEG-4, moreover, a standardization achieving yet higher encoding efficiency by using the H.26L as a base and incorporating a function not supported in the H.26L has currently been in the process as Joint Model of Enhanced-Compression Video Coding. This became an international standard in March, 2003 under the name of H.264 and MPEG-4 Part 10 (Advanced Video Coding; hereinafter noted as AVC).

However, it was concerned that a macroblock size of 16 pixels×16 pixels was not optimal for a large picture frame provided in UHD (Ultra High Definition 4000 pixels×2000 pixels) which is to be the target for a next-generation encoding scheme.

Accordingly, a JCTVC (Joint Collaboration Team-video Coding) that is a joint standardization group formed by the ITU-T and the ISO/IEC is currently working to standardize an encoding scheme called an HEVC (High Efficiency Video Coding) for the purpose of further improving the encoding efficiency achieved by the AVC (refer to Non-Patent Document 1, for example).

The HEVC encoding scheme defines a coding unit (CU) as a processing unit similar to the macroblock used in the AVC. Unlike the macroblock used in the AVC, the size of the CU is not fixed to 16×16 pixels but specified within image compression information in each sequence.

Now, in order to improve encoding of a motion vector employing median prediction in the AVC, there has been proposed to adaptively use any of a “temporal predictor” and a “spatio-temporal predictor”, in addition to a “spatial predictor” required in the median prediction and defined in the AVC, as predictive motion vector information (hereinafter also referred to as MV competition) (refer to Non-Patent Document 2, for example).

### CITATION LIST

### Non-Patent Document

Non-Patent Document 1: Thomas Wiegand, Woo-Jin Han, Benjamin Bross, Jens-Rainer Ohm, Gary J. Sullivan, “Working Draft 1 of High-Efficiency Video Coding”, JCTVC-C403, Joint Collaborative Team on Video Coding (JCT-VC) of ITU-T SG16 WP3 and ISO/IEC JTC1/SC29/WG113rd Meeting: Guangzhou, C N, 7-15 Oct., 2010
Non-Patent Document 2: Joel Jung, Guillaume Laroche, “Competition-Based Scheme for Motion Vector Selection and Coding”, VCEG-AC06, ITU—Telecommunications Standardization SectorSTUDY GROUP 16 Question SVideo Coding Experts Group (VCEG)29th Meeting: Klagenfurt, Austria, 17-18 Jul., 2006.

### SUMMARY OF THE INVENTION

### Problems to be Solved by the Invention

However, there is a possibility in an encoding process of a motion vector using a “temporal predictor” that the efficiency of encoding the motion vector decreases depending on the area of a co-located region which is a region including a pixel having the same address as a pixel in the upper left part of the region to be processed of a region within a reference image. In other words, the area shared between the region to be processed and the co-located region decreases when a region with a small area corresponds to the co-located region, the region being one of a plurality of regions into which the reference image is divided. Accordingly, there is a possible decrease in the efficiency of encoding the motion vector because the correlation between motion vector information of the region to be processed and motion vector information of the co-located region is decreased.

The present technique has been made in consideration of such situation and has allowed the efficiency of encoding the motion vector to be increased.

### Solutions to Problems

An image processing apparatus according to a first aspect of the present technique includes: a determination unit which determines, in performing motion prediction on an image, an extraction region from which motion vector information is extracted as temporal predictive motion vector information from within a reference region in a reference image, the reference region corresponding to a current region to be processed; and a difference generation unit which generates differential motion information that is the difference between the temporal predictive motion vector information extracted from the extraction region determined by the determination unit and motion information of the current region. The reference region is partitioned into a plurality of divided regions and, from among the plurality of divided regions of the reference region, the determination unit determines a largest region having the largest area of overlap with the current region to be the extraction region.

The determination unit can have a rule that, when there exists a plurality of the largest regions, the extraction region is determined from among the plurality of largest regions.

The rule can be set such that the largest region appearing first when tracing the reference region in the order it is raster-scanned is determined to be the extraction region.

Moreover, the rule can be set such that the largest region encoded by inter prediction and appearing first when tracing the reference region in the order it is raster-scanned is determined to be the extraction region.

Where the reference region is partitioned into the plurality of divided regions, the determination unit can determine the largest region having the largest area of overlap with the current region to be the extraction region from among the plurality of divided regions within the reference region, when the size of the current region is larger than or equal to a predetermined threshold. When the size of the current region is smaller than the predetermined threshold, the determination unit can determine the divided region including a pixel having the same address as a pixel in the upper left part of the current region to be the extraction region from among the plurality of divided regions within the reference region.

The predetermined threshold can be specified in a sequence parameter set, a picture parameter set, or a slice header in image compression information that is to be the input.

When a profile level in the image compression information to be the output is equal to a predetermined threshold or higher, the determination unit can determine the largest region having the largest area of overlap with the current region to be the extraction region from among the plurality of divided regions within the reference region. When the profile level in the image compression information to be the output is lower than the predetermined threshold, the determination unit can determine the divided region including the pixel having the same address as the pixel in the upper left part of the current region to be the extraction region from among the plurality of divided regions within the reference region.

The profile level can be a picture frame.

An image processing method according to the first aspect of the present technique corresponds to the aforementioned image processing apparatus according to the first aspect of the present technique.

The image processing apparatus and method according to the first aspect of the present technique are provided so that, in performing the motion prediction on the image, the extraction region from which the motion vector information is extracted as the temporal predictive motion vector information is determined from within the reference region in the reference image corresponding to the current region to be processed, and the differential motion information, which is the difference between the temporal predictive motion vector information extracted from the extraction region being determined and the motion information of the current region, is generated.

The reference region is partitioned into the plurality of divided regions and, from among the plurality of divided regions within the reference region, the largest region having the largest area of overlap with the current region is determined to be the extraction region.

An image processing apparatus according to a second aspect of the present technique includes: an acquisition unit which acquires, in decoding encoded data of an image, differential motion information that is the difference between temporal predictive motion vector information used in encoding the image and motion information of a current region to be processed; a determination unit which determines an extraction region, from which motion vector information is extracted as the temporal predictive motion vector information, from within a reference region in a reference image corresponding to the current region to be processed; and a motion information reconstruction part which reconstructs the motion information of the current region provided for motion compensation by using the differential motion information acquired by the acquisition unit and the temporal predictive motion vector information extracted from the extraction region determined by the determination unit. The reference region is partitioned into a plurality of divided regions and, from among the plurality of divided regions within the reference region, the determination unit determines a largest region having the largest area of overlap with the current region to be the extraction region.

The determination unit can have a rule that, when there exists a plurality of the largest regions, the extraction region is determined from among the plurality of largest regions.

The rule can be set such that the largest region appearing first when tracing the reference region in the order it is raster-scanned is determined to be the extraction region.

Moreover, the rule can be set such that the largest region encoded by inter prediction and appearing first when tracing the reference region in the order it is raster-scanned is determined to be the extraction region.

Where the reference region is partitioned into the plurality of divided regions, the determination unit can determine the largest region having the largest area of overlap with the current region to be the extraction region from among the plurality of divided regions within the reference region, when the size of the current region is larger than or equal to a predetermined threshold. When the size of the current region is smaller than the predetermined threshold, the determination unit can determine the divided region including a pixel having the same address as a pixel in the upper left part of the current region to be the extraction region from among the plurality of divided regions within the reference region.

The predetermined threshold can be specified in a sequence parameter set, a picture parameter set, or a slice header in image compression information that is to be the input.

When a profile level in the image compression information to be the output is equal to a predetermined threshold or higher, the determination unit can determine the largest region having the largest area of overlap with the current region to be the extraction region from among the plurality of divided regions within the reference region. When the profile level in the image compression information to be the output is lower than the predetermined threshold, the determination unit can determine the divided region including the pixel having the same address as the pixel in the upper left part of the current region to be the extraction region from among the plurality of divided regions within the reference region.

The profile level can be a picture frame.

An image processing method according to the second aspect of the present technique corresponds to the aforementioned image processing apparatus according to the second aspect of the present technique.

The image processing apparatus and method according to the second aspect of the present technique are provided so that, in decoding the encoded data of the image, the differential motion information that is the difference between the temporal predictive motion vector information used in encoding the image and the motion information of the current region to be processed is acquired, the extraction region from which the motion vector information is extracted as the temporal predictive motion vector information is determined from within the reference region in the reference image corresponding to the current region, and the motion information of the current region provided for motion compensation is reconstructed by using the differential motion information and the temporal predictive motion vector information extracted from the extraction region. The reference region is partitioned into the plurality of divided regions and from among the plurality of divided regions within the reference region, the largest region having the largest area of overlap with the current region is determined to be the extraction region.

### Effects of the Invention

As described above, the efficiency of encoding the motion vector can be increased according to the present technique.

### BRIEF DESCRIPTION OF DRAWINGS

FIG. 1 is a block diagram illustrating an example of a main configuration of an image encoding device.

FIG. 2 is a diagram illustrating an example of a motion prediction/compensation process with decimal pixel precision.

FIG. 3 is a diagram illustrating an example of a macroblock.

FIG. 4 is a diagram illustrating an example of how a median operation is performed.

FIG. 5 is a diagram illustrating an example of a multi-reference frame.

FIG. 6 is a diagram illustrating an example of how a temporal direct mode is performed.

FIG. 7 is a diagram illustrating an example of how a motion vector encoding method is performed.

FIG. 8 is a diagram illustrating an example of a configuration of a coding unit.

FIG. 9 is a diagram illustrating an example of how Motion Partition Merging is performed.

FIG. 10 is a diagram illustrating the area of a co-located region.

FIG. 11 is a diagram illustrating how a region from which temporal predictive motion vector information is extracted is determined.

FIG. 12 is a block diagram illustrating an example of a detailed configuration of a motion prediction/compensation unit, a temporal predictive motion vector information determination unit, and a motion vector encoding unit.

FIG. 13 is a flowchart illustrating the flow of an encoding process.

FIG. 14 is a flowchart illustrating an example of a flow of an inter motion prediction process.

FIG. 15 is a flowchart illustrating the flow of a process of determining the region from which the temporal predictive motion vector information is extracted.

FIG. 16 is a block diagram illustrating an example of a main configuration of an image decoding device.

FIG. 17 is a block diagram illustrating an example of a detailed configuration of the motion prediction/compensation unit, the temporal predictive motion vector information determination unit, and a motion vector decoding unit.

FIG. 18 is a flowchart illustrating the flow of a decoding process.

FIG. 19 is a flowchart illustrating the flow of a prediction process.

FIG. 20 is a flowchart illustrating an example of a flow of an inter motion prediction process.

FIG. 21 is a block diagram illustrating an example of a main configuration of a computer.

FIG. 22 is a block diagram illustrating an example of a schematic configuration of a television device.

FIG. 23 is a block diagram illustrating an example of a schematic configuration of a mobile telephone.

FIG. 24 is a block diagram illustrating an example of a schematic configuration of a recording/reproducing device.

FIG. 25 is a block diagram illustrating an example of a schematic configuration of an imaging device.

### MODES FOR CARRYING OUT THE INVENTION

Modes for carrying out the present technique (hereinafter referred to as embodiments) will be described below. The description will be provided in the following order.

1. First embodiment (an image encoding device)
2. Second embodiment (an image decoding device)
3. Third embodiment (a computer)
4. Fourth embodiment (a television set)
5. Fifth embodiment (a mobile telephone)
6. Sixth embodiment (a recording/reproducing device)
7. Seventh embodiment (an imaging device)

### 1. First Embodiment

### Image Encoding Device

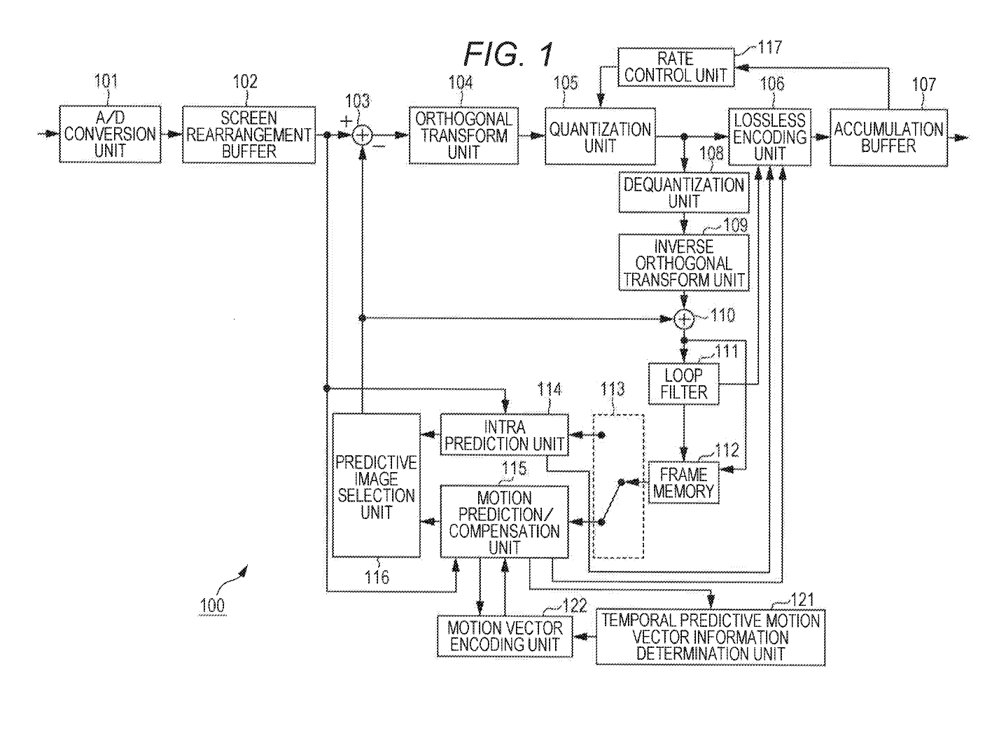

FIG. 1 is a block diagram illustrating an example of a main configuration of an image encoding device.

An image encoding device 100 illustrated in FIG. 1 encodes image data while employing a prediction process as performed in an encoding scheme such as H.264 or MPEG (Moving Picture Experts Group) 4 Part 10 (AVC (Advanced Video Coding)).

As illustrated in FIG. 1, the image encoding device 100 includes an A/D conversion unit 101, a screen rearrangement buffer 102, a calculator 103, an orthogonal transform unit 104, a quantization unit 105, a lossless encoding unit 106 and an accumulation buffer 107. Further, the image encoding device 100 includes a dequantization unit 108, an inverse orthogonal transform unit 109, a calculator 110, a loop filter 111, a frame memory 112, a selection unit 113, an intra prediction unit 114, a motion prediction/compensation unit 115, a predictive image selection unit 116, and a rate control unit 117.

The image encoding device 100 further includes a temporal predictive motion vector information determination unit 121 and a motion vector encoding unit 122.

The A/D conversion unit 101 performs A/D conversion on input image data and supplies the converted image data (digital data) to the screen rearrangement buffer 102 so as to store the converted image data therein. The screen rearrangement buffer 102 rearranges a frame arranged in the order of display in the stored image into the order adopted for encoding in accordance with GOP (Group Of Picture), and thereafter supplies the image with the rearranged frame order to the calculator 103. The screen rearrangement buffer 102 further supplies the image with the rearranged frame order to the intra prediction unit 114 and the motion prediction/compensation unit 115.

The calculator 103 subtracts a predictive image supplied by the intra prediction unit 114 or the motion prediction compensation unit 115 via the predictive image selection unit 116 from the image read out of the screen rearrangement buffer 102, and outputs the differential information to the orthogonal transform unit 104.

When the image is subjected to inter encoding, for example, the calculator 103 subtracts the predictive image supplied by the motion prediction/compensation unit 115 from the image read out of the screen rearrangement buffer 102.

The orthogonal transform unit 104 performs an orthogonal transform such as a discrete cosine transform or a Karhunen-Loeve transform on the differential information supplied from the calculator 103. Note that the orthogonal transform method is selected arbitrarily. The orthogonal transform unit 104 then supplies the transform coefficient to the quantization unit 105.

The quantization unit 105 quantizes the transform coefficient supplied from the orthogonal transform unit 104. That is, the quantization unit 105 sets a quantization parameter on the basis of information regarding a target value of a code amount supplied from the rate control unit 117 and performs the quantization. Note that a method of this quantization is selected arbitrarily. The quantization unit 105 then supplies the quantized transform coefficient to the lossless encoding unit 106.

The lossless encoding unit 106 encodes the transform coefficient quantized in the quantization unit 105 by employing an arbitrary encoding scheme. Since the coefficient data is quantized under control of the rate control unit 117, the code amount corresponds with the target value set by the rate control unit 117 (or approaches to the target value).

Furthermore, the lossless encoding unit 106 acquires information representing a mode of intra prediction and the like from the intra prediction unit 114 and acquires information representing a mode of inter prediction, motion vector information and the like from the motion prediction/compensation unit 115. The lossless encoding unit 106 further acquires a filter coefficient and the like used in the loop filter 111.

The lossless encoding unit 106 encodes these various pieces of information by an arbitrary encoding scheme and makes it a part of header information of the encoded data (i.e., multiplexing). The lossless encoding unit 106 then supplies the encoded data obtained by the encoding to the accumulation buffer 107 and accumulates the data therein.

The lossless encoding unit 106 can employ variable length encoding or arithmetic encoding, for example, as the encoding scheme. CAVLC (Context-Adaptive Variable Length Coding) specified in the H.264/AVC scheme, for example, can be employed as the variable length encoding. CABAC (Context-Adaptive Binary Arithmetic Coding) can be employed as the arithmetic encoding, for example.

The accumulation buffer 107 temporarily holds the encoded data supplied from the lossless encoding unit 106. At a predetermined timing, the accumulation buffer 107 outputs the encoded data being held therein to a recording device (a recording medium) or a transmission path that is not shown but disposed in a following stage.

The transform coefficient quantized in the quantization unit 105 is also supplied to the dequantization unit 108. The dequantization unit 108 dequantizes the quantized transform coefficient by a method corresponding to the quantization performed by the quantization unit 105. The dequantization method may be any method as long as it corresponds to the quantization process performed by the quantization unit 105. The dequantization unit 108 supplies the transform coefficient obtained to the inverse orthogonal transform unit 109.

The inverse orthogonal transform unit 109 performs an inverse orthogonal transform on the transform coefficient supplied from the dequantization unit 108 by a method corresponding to an orthogonal transform process performed by the orthogonal transform unit 104. The inverse orthogonal transform method may be any method as long as it corresponds to the orthogonal transform process performed by the orthogonal transform unit 104. The output (restored differential information) that has undergone the inverse orthogonal transform is supplied to the calculator 110.

The calculator 110 adds a predictive image supplied from the intra prediction unit 114 or the motion prediction/compensation unit 115 via the predictive image selection unit 116 to the outcome of the inverse orthogonal transform supplied from the inverse orthogonal transform unit 109, namely, the restored differential information. The calculator 110 thereby acquires a locally decoded image (a decoded image), which is supplied to the loop filter 111 or the frame memory 112.

The loop filter 111 including a deblocking filter and an adaptive loop filter performs the filter process on the decoded image supplied from the calculator 110 as deemed appropriate. The loop filter 111 removes block distortion in the decoded image, for example, by performing a deblocking filter process on the decoded image. The loop filter 111 also improves image quality by performing a loop filter process on the outcome of the deblocking filter process (the decoded image from which the block distortion has been removed) by using a Wiener filter, for example.

Note that the loop filter 111 may be adapted to perform an arbitrary filter process on the decoded image. The loop filter ill can also supply information such as a filter coefficient used in the filter process to the lossless encoding unit 106 as needed in order to encode the information.

The loop filter 111 supplies the outcome of the filter process (the decoded image following the filter process) to the frame memory 112. Note that the decoded image output from the calculator 110 can be supplied to the frame memory 112 without passing through the loop filter 111 as described above, meaning that the filter process by the loop filter 111 can be omitted.

The frame memory 112 stores the decoded image supplied thereto and supplies the stored decoded image to the selection unit 113 as a reference image at a predetermined timing.

The selection unit 113 selects a destination to which the reference image supplied from the frame memory 112 is supplied. When performing the inter prediction, for example, the selection unit 113 supplies the reference image supplied from the frame memory 112 to the motion prediction/compensation unit 115.

The intra prediction unit 114 uses a pixel value within a picture to be processed that is the reference image supplied from the frame memory 112 through the selection unit 113 and performs intra prediction (intra-picture prediction) that generates a predictive image with a prediction unit (PU) as a basic processing unit. The intra prediction unit 114 performs this intra prediction in a plurality of modes (intra prediction modes) prepared in advance.

The intra prediction unit 114 generates a predictive image in all candidate intra prediction modes, evaluates a cost function value for each predictive image by using the input image supplied from the screen rearrangement buffer 102, and selects an optimal mode. Upon selecting the optimal intra prediction mode, the intra prediction unit 114 supplies the predictive image generated in the optimal mode to the predictive image selection unit 116.

Furthermore, as described above, the intra prediction unit 114 appropriately supplies intra prediction mode information or the like representing the adopted intra prediction mode to the lossless encoding unit 106, which then encodes the information.

The motion prediction/compensation unit 115 performs motion prediction (inter prediction) with the PU as a basic processing unit by using the input image supplied from the screen rearrangement buffer 102 and the reference image supplied from the frame memory 112 through the selection unit 113, performs a motion compensation process in accordance with a motion vector detected, and generates a predictive image (inter predictive image information). The motion prediction/compensation unit 115 performs this inter prediction in a plurality of modes (inter prediction modes) prepared in advance.

The motion prediction/compensation unit 115 generates a predictive image in all candidate inter prediction modes, evaluates a cost function value for each predictive image, and selects an optimal mode. Upon selecting the optimal inter prediction mode, the motion prediction/compensation unit 115 supplies the predictive image generated in the optimal mode to the predictive image selection unit 116,

Furthermore, the motion prediction/compensation unit 115 supplies information representing the adopted inter prediction mode and information required to perform a process in the inter prediction mode in decoding the encoded data to the lossless encoding unit 106, which then encodes the information,

The motion prediction/compensation unit 115 further supplies temporal neighboring motion information to the temporal predictive motion vector information determination unit 121 and supplies spatial neighboring motion information and the motion information to the motion vector encoding unit 122.

The predictive image selection unit 116 selects an origin from which the predictive image is supplied to the calculator 103 and the calculator 110. When performing the inter encoding, for example, the predictive image selection unit 116 selects the motion prediction/compensation unit 115 as the origin from which the predictive image is supplied, and supplies the predictive image supplied from the motion prediction/compensation unit 115 to the calculator 103 and the calculator 110.

The rate control unit 117 controls the rate of quantizing operation performed by the quantization unit 105 on the basis of the code amount of the encoded data accumulated in the accumulation buffer 107 so as not to cause overflow or underflow.

The temporal predictive motion vector information determination unit 121 determines information to be used as temporal predictive motion vector information from among the temporal neighboring motion information supplied from the motion prediction/compensation unit 115, and supplies the determined temporal predictive motion vector information to the motion vector encoding unit 122.

The motion vector encoding unit 122 determines information to be used as spatial predictive motion vector information from among the spatial neighboring motion information supplied from the motion prediction/compensation unit 115. The motion vector encoding unit 122 then selects an appropriate piece of predictive motion vector information from the determined spatial predictive motion vector information and the temporal predictive motion vector information supplied from the temporal predictive motion vector information determination unit 121. Subsequently, the motion vector encoding unit 122 finds the differential motion information between the selected predictive motion vector information and the motion information supplied from the motion prediction/compensation unit 115.

The motion prediction/compensation unit 115 uses the differential motion information or the like found by the motion vector encoding unit 122 to perform a process such as MV competition or merge mode.

### [Quarter-Pixel Precision Motion Prediction]

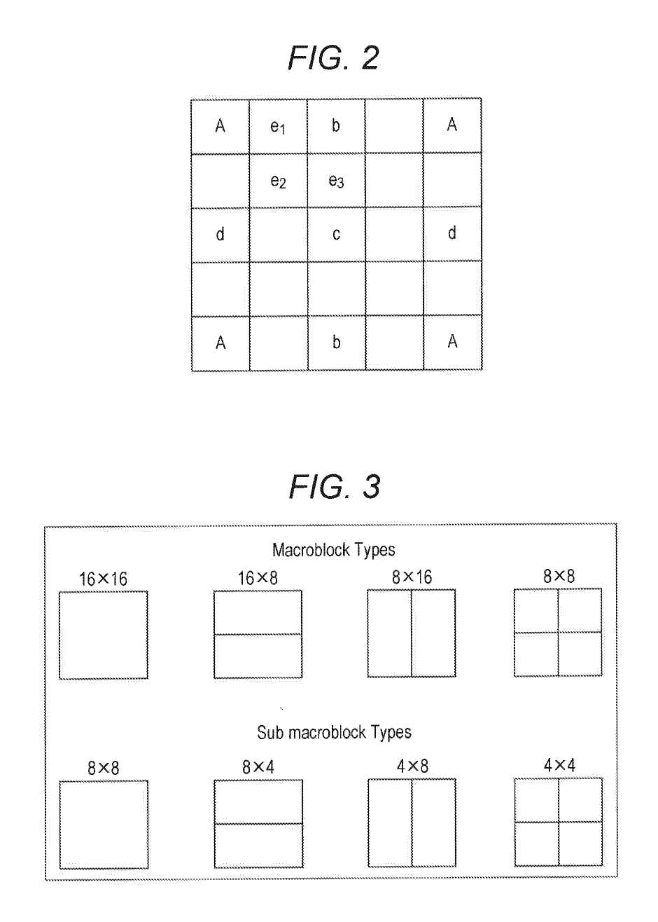

FIG. 2 is a diagram illustrating an example of how the motion prediction/compensation process with quarter-pixel precision specified by the AVC encoding scheme is performed. Each quadrangle in FIG. 2 represents a pixel. The quadrangle indicated by A represents a position of a pixel having integer precision stored in the frame memory 112. The quadrangle indicated by b, c, and d represents a position with half-pixel precision. The quadrangle indicated by e1, e2, and e3 represents a position with quarter-pixel precision.

A function Clip1( ) will be hereinafter defined as the following expression (1).

$$\begin{matrix}[ Expression 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

For example, the value of max_pix in expression (1) is 255 when the input image has 8-bit precision.

The pixel value for each of the positions b and d is generated as expressed in the following expressions (2) and (3) while using a 6-tap FIR filter.

[Expression 2]

F=A₋₂−5·A₋₁+20·A₀+20·A₁−5·A₂+A₃ (2)

[Expression 3]

b,d=Clip1((F+16)>>5) (3)

The pixel value for the position indicated by c is generated as expressed in the following expressions (4) to (6) while applying the 6-tap FIR filter in horizontal and vertical directions.

[Expression 4]

F=b₋₂−5·b₋₁+20·b₀+20·b₁−5·b₂+b₃ (4)

or,

[Expression 5]

F=d₋₂−5·d₋₁+20·d₀+20·d₁−5·d₂+d₃ (5)

[Expression 6]

c=Clip1((F+512)>>10) (6)

Note that a Clip process is performed only once at the end after performing a product-sum operation in both the horizontal direction and the vertical direction.

The value for each of the positions e1 to e3 is generated by linear interpolation as expressed in the following expressions (7) to (9).

[Expression 7]

e₁=(A+b+1)>>1 (7)

[Expression 8]

e₂=(b+d+1)>>1 (8)

[Expression 9]

e₃=(b+c+1)>>1 (9)

### [Macroblock]

The MPEG-2 performs the motion prediction/compensation process by the unit of 16×16 pixels in a frame motion compensation mode and 16×8 pixels in each of a first field and a second field in a field motion compensation mode.

In the AVC scheme, on the other hand, a single macroblock configured by 16×16 pixels can be partitioned into 16×16, 16×8, 8×16, or 8×8 pixels as illustrated in FIG. 3 so that each sub macroblock can have independent motion vector information. The partition of 8×8 pixels can be further divided into any sub macroblock of 8×8, 8×4, 4×8, or 4×4 pixels as illustrated in FIG. 3 so that each can have independent motion vector information.

It has been concerned, however, that a large amount of motion vector information is generated in the AVC image encoding scheme when the motion prediction/compensation process is performed in the same manner as is performed in the MPEG-2. It has therefore been concerned that encoding the large amount of generated motion vector information altogether causes the encoding efficiency to decrease.

### [Median Prediction in Motion Vector]

As a method which solves the aforementioned problem, the AVC image encoding has implemented the following method and reduced the amount of encoding information for the motion vector.

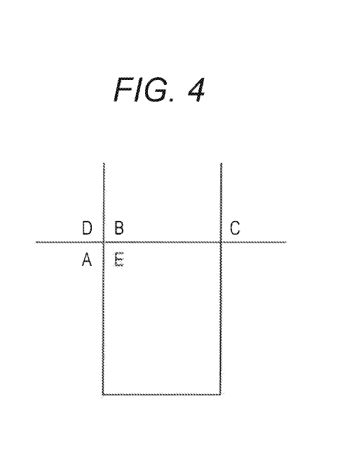

Each straight line illustrated in FIG. 4 represents a boundary of a motion compensation block. In FIG. 4, a letter E represents a current motion compensation block which is to be encoded, while each of letters A to D represents a motion compensation block which has already been encoded and is adjacent to the block F.

Now, let X=A, B, C, D, and E, and the motion vector information for X be mvₓ.

First, the motion vector information for the motion compensation blocks A, B, and C is used to generate predictive motion vector information pmv_{E} for the motion compensation block E by a median operation as expressed in the following expression (10).

[Expression 10]

pmv_{E}=med(mv_{A},mv_{B},mv_{C}) (10)

The information for the motion compensation block D is substituted for the information for the motion compensation block C when the information for the motion compensation block C is unavailable because it is at the edge of the picture frame, for example.

Data mvd_{E} that is encoded as the motion vector information for the motion compensation block E in the image compression information is generated by using pmv_{E} as expressed in the following expression (11).

[Expression 11]

mvd_{E}=mv_{E}−pmv_{E}

Note that the actual process is performed independently for each of the horizontal and vertical components of the motion vector information.

### [Multi-Reference Frame]

Also specified in the AVC is a system called a multi-reference frame that has not been specified in the conventional image encoding scheme such as the MPEG-2 and the H.263.

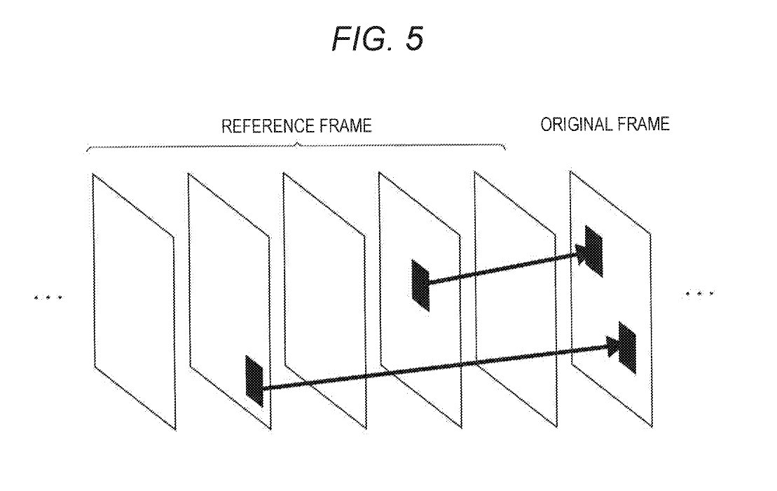

The multi-reference frame specified in the AVC will now be described with reference to FIG. 5.

The MPEG-2 and the H.263 have performed the motion prediction/compensation process by referring to a single reference frame stored in the frame memory when using P picture whereas, as illustrated in FIG. 5, the AVC has a plurality of reference frames stored in a memory so that a different memory can be referred for each macroblock.

### [Direct Mode]

While the enormous amount of motion vector information is involved in employing B picture, the AVC is provided with a mode referred to as a direct mode.

The motion vector information is not stored in the image compression information in the direct mode. The image decoding device calculates the motion vector information of the current block from motion vector information of a neighboring block or motion vector information of a co-located block in the reference frame, the co-located block being located at the same position as the block to be processed.

The direct mode includes a spatial direct mode and a temporal direct mode which can be switched therebetween in every slice.

The spatial direct mode calculates the motion vector information mv_{E} for the motion compensation block E to be processed as expressed in the following expression (12).

mv_{E}=pmv_{E} (12)

That is, the motion vector information generated by median prediction is applied to the current block.

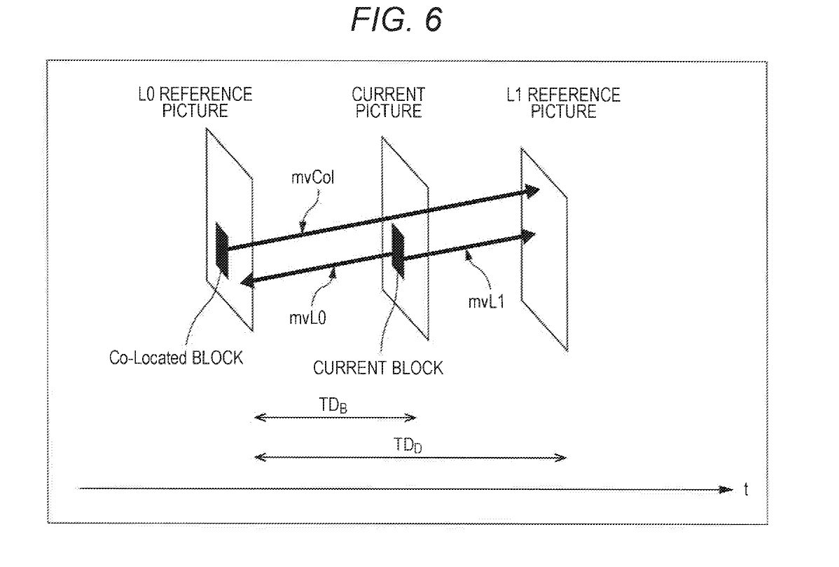

The temporal direct mode will now be described with reference to FIG. 6.

In FIG. 6, the co-located block in a reference picture L0 is a block located at the same spatial address as the current block, while motion vector information in the co-located block is denoted as mv_{col}. A distance between a current picture and the reference picture L0 along a temporal axis is denoted as TD_{B}, while a distance between the reference picture L0 and a reference picture L1 along the temporal axis is denoted as TD_{D}.

Here, motion vector information mv_{L0} for L0 and motion vector information mv_{L1} for L1 in the current picture are calculated by the following expressions (13) and (14).

$$\begin{matrix}[ Expression 12 ] & \\ {mv}_{L 0} = \frac{{TD}_{B}}{{TD}_{D}} {mv}_{col} & ( 13 ) \\ [ Expression 13 ] & \\ {mv}_{L 1} = \frac{{TD}_{D} - {TD}_{B}}{{TD}_{D}} {mv}_{col} & ( 14 )\end{matrix}$$

Note that the information TO representing the distance along the temporal axis does not exist in the AVC image compression information, whereby POC (Picture Order Count) is employed to carry out the calculations in the aforementioned expressions (12) and (13).

Moreover, the direct mode in the AVC image compression information can be defined by the macroblock unit of 16×16 pixels or the block unit of 8×8 pixels.

### [Selection of Prediction Mode]

It is important in the AVC encoding scheme to select an appropriate prediction mode in order to achieve higher encoding efficiency.

A method implemented in reference software for the H.264/MPEG-4 AVC called a JM (Joint Model) (disclosed in http://iphome.hhi.de/suehring/tml/index.htm) is an example of such selection scheme.

The JM can select between two mode determination methods for a high complexity mode and a low complexity mode to be described hereinafter. Both of the methods calculate a cost function value for each prediction mode and select a prediction mode with the minimum cost function value as an optimal mode for the current sub macroblock or the current macroblock.

The cost function in the high complexity mode is expressed by the following expression (15).

Cost(Mode εΩ)=D+λ*R (15)

Here, Ω denotes a universal set of candidate modes that encode the current block or macroblock, D denotes energy difference between a decoded image and an input image when encoding is performed in the current prediction mode, λ denotes a Lagrange undetermined multiplier given as a function of a quantization parameter, and R denotes a total code amount including an orthogonal transform coefficient when encoding is performed in the current mode.

This means that the encoding process in the high complexity mode requires more calculation because a provisional encoding process needs to be performed once in all the candidate modes to calculate the parameters D and R.

The cost function in the low complexity mode is expressed by the following expression (16).

Cost(Mode εΩ)=D+QP2Quant(QP)*HeaderBit (16)

Different from the high complexity mode, D here denotes energy difference between a predictive image and an input image. QP2Quant (QP) is given as a function of a quantization parameter QP while HeaderBit is a code amount related to information pertaining to a header such as the motion vector and a mode, not including the orthogonal transform coefficient.

This means that the low complexity mode requires a prediction process in each candidate mode but not a decoded image, thereby not requiring an encoding process. The low complexity mode can thus be realized with less calculation than the high complexity mode.

### [Motion Vector Competition]

Now, Non-Patent Document 1 proposes the following method in order to improve the encoding process of the motion vector using the median prediction as described with reference to FIG. 4.

The method allows any of a “temporal predictor” and a “spatio-temporal predictor” which are to be described below in addition to a “spatial predictor” obtained by the median prediction and defined in the AVC to be adaptively used as the predictive motion vector information.

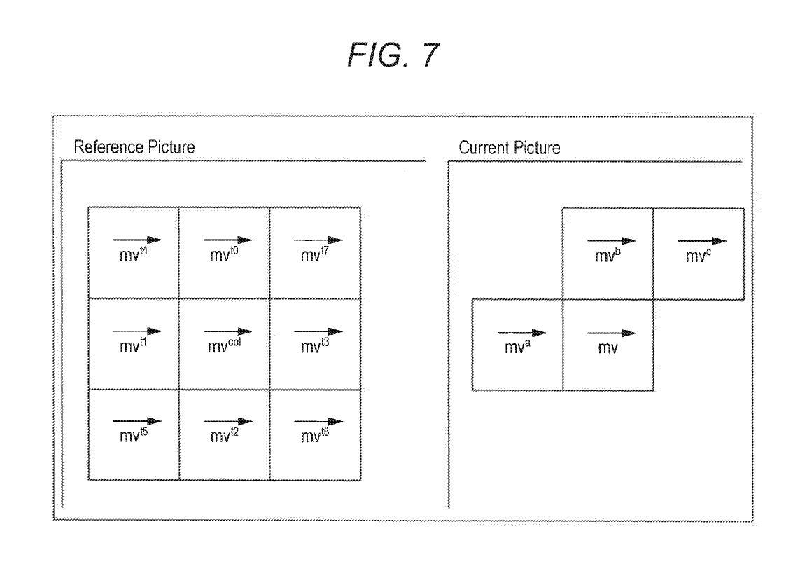

That is, in FIG. 7, each of the predictive motion vector information (predictors) is defined by the following expressions (17) to (19) while letting “mvcol” be motion vector information for a co-located block (a block in a reference image, the block having the same x-y coordinates as that of the current block) corresponding to the current block and letting mvₜₖ (k=0 to 8) be motion vector information for the neighboring block.

Temporal Predictor:

[Expression 14]

mvₜₘ₅=median{mv_{col},mvₜ₀, . . . , mvₜ₃} (17)

[Expression 15]

mvₜₘ₉=median{mv_{col},mvₜ₀, . . . , mvₜ₈} (18)

Spatio-Temporal Predictor:

[Expression 16]

mvₛₚₜ=median{mv_{col},mv_{col},mvₐ,mv_{b},mv_{c}} (19)

The image encoding device 100 calculates a cost function for each block in which each of the predictive motion vector information is used and selects optimal predictive motion vector information. A flag representing information on which of the predictive motion vector information is used in each block is transmitted to the image compression information.

Note that the spatial predictor is hereinafter referred to as the spatial predictive motion vector information, and the temporal predictor is hereinafter referred to as the temporal predictive motion vector information.

### [Coding Unit]

Now, the macroblock size of 16 pixels×16 pixels is not optimal for a large picture frame with UHD (Ultra High Definition; 4000 pixels×2000 pixels) which is to be the target for a next-generation encoding scheme.

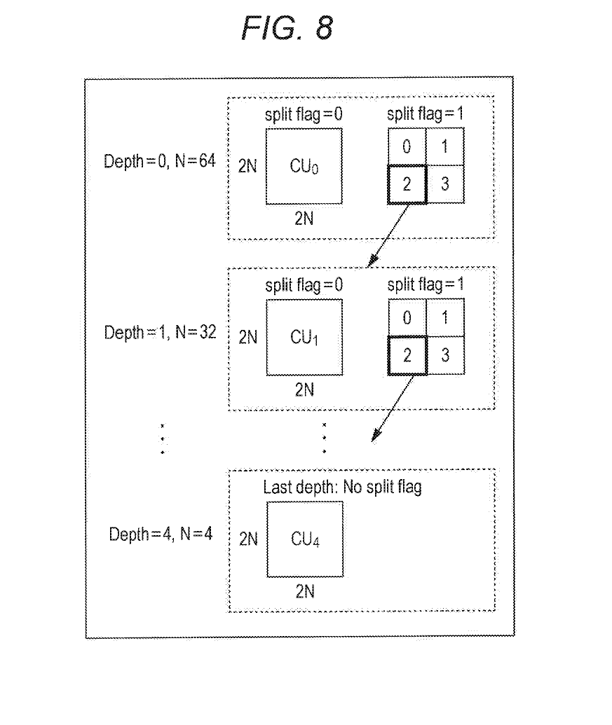

The AVC specifies the hierarchical structure including the macroblock and the sub macroblock as illustrated in FIG. 3, while HEVC (High Efficiency Video Coding), for example, specifies a coding unit (CU) as illustrated in FIG. 8.

Also referred to as a coding tree block (CTB), the CU is a partial region of an image in a picture unit and plays the similar role to that of the macroblock in the AVC. The latter has the fixed size of 16×16 pixels, whereas the size of the former is unfixed and thus specified in the image compression information in each sequence.

For example, the largest size (LCU (Largest Coding Unit)) and the smallest size (SCU (Smallest Coding Unit)) of the CU are specified in a sequence parameter set (SPS) included in the encoded data to be the output.

Each LOU can be further divided into a smaller CU by setting split_flag=1 within the range not falling below the size of the SCU. In an example illustrated in FIG. 8, the LCU is 128×128 pixels in size while the maximum hierarchical depth is 5. The CU with 2N×2N pixels in size is divided into the CU with N×N pixels in size that is one level lower in the hierarchy when the value of split_flag “1”.

The CU is further divided into a prediction unit (PU) that is a region (a partial region of an image in a picture unit) to be a processing unit for the intra prediction or the inter prediction and then into a transform unit (TU) that is a region (a partial region of an image in a picture unit) to be a processing unit for the orthogonal transform. The HEVC can currently perform the orthogonal transform with 16×16 pixels and 32×32 pixels in addition to 4×4 pixels and 8×8 pixels.

It can be considered that, when the encoding scheme such as the HEVC described above performs a variety of processes by defining the CU and using the CU as a unit, the macroblock in the AVC corresponds to the LCU. The CU however has the hierarchical structure as illustrated in FIG. 8, whereby it is generally the case that the size of the LCU in the uppermost level of the hierarchy, such as 128×128 pixels, is set larger than the size of the macroblock in the AVC.

### [Motion Partition Merging]

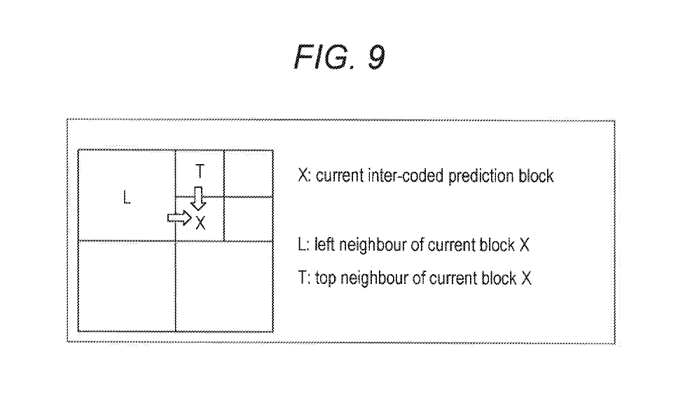

A method referred to as Motion Partition Merging (merge mode) has been proposed as one of the schemes for encoding the motion information, as illustrated in FIG. 9. In this method, two flags including MergeFlag and MergeLeftFlag are transmitted as merge information relevant to the merge mode. The flag MergeFlag=1 indicates that the motion information of a current region X being the region to be processed is identical to the motion information of a neighboring region T adjacent above the current region X or a neighboring region L adjacent to the left of the current region X. At this time, the merge information being transmitted includes the MergeLeftFlag. The flag MergeFlag=0 indicates that the motion information of the current region X differs from the either motion information of the neighboring region T and the neighboring region L. The motion information of the current region X is transmitted in this case.

### [Area of Co-Located Region]

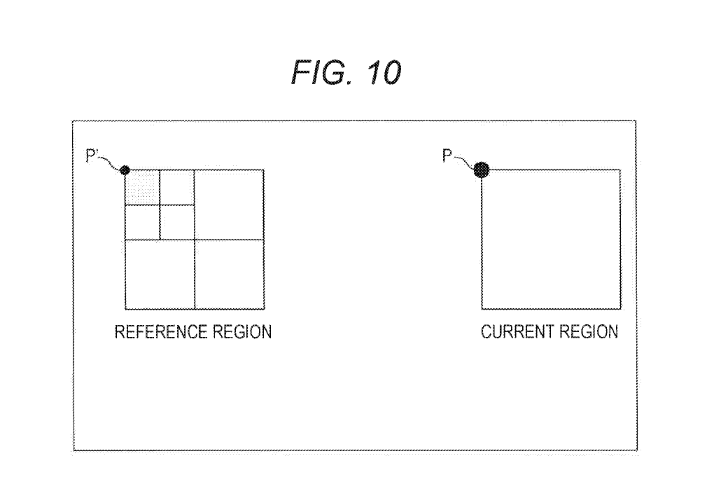

Depending on the area of a co-located region, the efficiency of encoding the motion vector possibly decreases when the process of encoding the motion vector is performed by using the temporal predictive motion vector information. The co-located region is a region that is located within the reference image and has the same x-y coordinates as the current region. A specific example where the encoding efficiency decreases will be described with reference to FIG. 10.

FIG. 10 is a diagram illustrating the area of the co-located region. The left figure in FIG. 10 indicates a reference region, while the right figure indicates a current region. The reference region is a region that is in the reference image and corresponds to the current region.

It is assumed that the reference region is divided into a plurality of regions (the CUs or the PUs) as illustrated in FIG. 10. Note that each of the plurality of regions divided in the reference region is hereinafter referred to as a divided region. Where the divided region in the reference region including a pixel P′ with the same address as that of a pixel P in the upper left part of the current region is determined to be the co-located region, the motion vector information of this co-located region is used as the temporal predictive motion vector information in performing the process of encoding the motion vector by using the temporal predictive motion vector information. However, there is a possibility that the efficiency of encoding the motion vector decreases when the area shared between the current region and the co-located region is small as illustrated in FIG. 10, because the correlation between the motion vector information of the current region and the motion vector information of the co-located region tends to decrease.

Now, the temporal predictive motion vector information determination unit 121 determines, from among the divided regions, a region having the largest area of overlap with the current region (hereinafter referred to as a largest region) to be the co-located region, namely, a region with the motion vector information that is extracted as the temporal predictive motion vector information (hereinafter referred to as a temporal predictive motion vector information extraction region). As a result, the motion vector information of the temporal predictive motion vector information extraction region (the co-located region) is used as the temporal predictive motion vector information. In this case, the correlation between the motion vector information of the current region and the motion vector information of the temporal predictive motion vector information extraction region often increases because the area shared between the current region and the temporal predictive motion vector information extraction region increases. The encoding efficiency of the motion vector increases as a result.

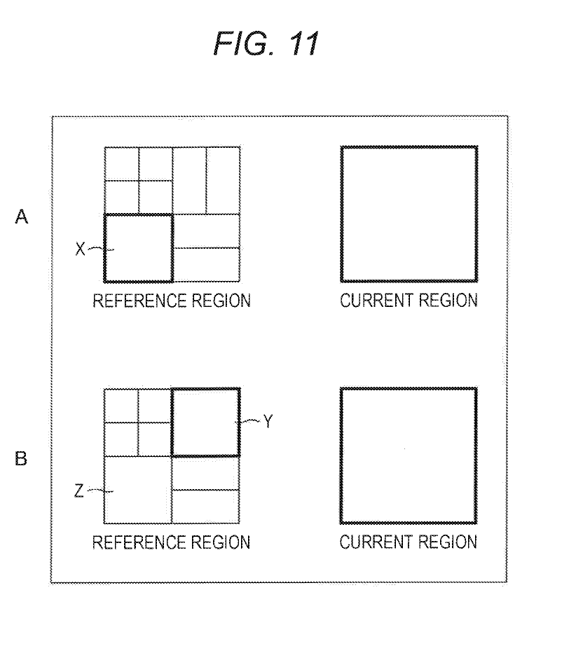

Next, the description of how the temporal predictive motion vector information determination unit 121 determines the temporal predictive motion vector information extraction region will be given with reference to FIG. 11.

### [Determination of Temporal Predictive Motion Vector Information Extraction Region]

FIG. 11 is a diagram illustrating how the temporal predictive motion vector information extraction region is determined. The left figure in each of case A and case B in FIG. 11 indicates a reference region, while the right figure indicates a current region.

The temporal predictive motion vector information determination unit 121 determines, from among divided regions, a largest region X to be the temporal predictive motion vector information extraction region when the reference region is divided into the plurality of regions as illustrated in the case A of FIG. 11. That is, the motion vector information of the largest region X (the co-located region) is used as the temporal predictive motion vector information. The area shared between the largest region X and the current region is large, meaning there is a high possibility that the largest region X has the motion vector information which is highly correlated to the motion vector information of the current region. Accordingly, the efficiency of encoding the motion vector is increased by using the motion vector information of the largest region X as the temporal predictive motion vector information. In the case where the largest region X is a region encoded by intra prediction and has no motion vector information, the divided region in the reference region including the pixel P′ with the same address as that of the pixel P in the upper left part of the current region is determined to be the temporal predictive motion vector information extraction region as is the case with the example illustrated in FIG. 10. That is, the motion vector information of the divided region (the co-located region) including the pixel P′ with the same address as that of the pixel P located in the upper left part of the current region used as the temporal predictive motion vector information. Note that the divided region in the reference region including the pixel P′ with the same address as that of the pixel P located in the upper left part of the current region is hereinafter referred to as an upper left region.

On the other hand, there are two largest regions Y and Z present among the divided regions when the reference region is divided into the plurality of regions as illustrated in the case B of FIG. 11. Here, the temporal predictive motion vector information determination unit 121 determines the temporal predictive motion vector information extraction region by following a predetermined rule when the plurality of largest regions is present in the divided regions. For example, one can adopt a rule, as the predetermined rule, that the largest region appearing first when the reference region is traced in the order it is raster-scanned (that is, a direction from left to right within a line and from up to down between lines) is determined to be the temporal predictive motion vector information extraction region. The temporal predictive motion vector information determination unit 121 can thus cut down the processing time required to determine the temporal predictive motion vector information extraction region. In the example illustrated by the case B in FIG. 11, the temporal predictive motion vector information determination unit 121 determines the largest region Y to be the temporal predictive motion vector information extraction region. This means that the motion vector information of the largest region Y (the co-located region) is used as the temporal predictive motion vector information.

In the example illustrated by the case B in FIG. 11, however, the largest region Z is determined to be the temporal predictive motion vector information extraction region when the largest region Y is a region encoded by intra prediction and has no motion vector information while the largest region Z is a region encoded by inter prediction and has motion vector information. That is, one can adopt a rule, as the predetermined rule, that the largest region encoded by inter prediction and appearing first when the reference region is traced in the order it is raster-scanned is determined to be the temporal predictive motion vector information extraction region. The motion vector information of the largest region Z (the co-located region) is used as the temporal predictive motion vector information in this case. Note that the temporal predictive motion vector information determination unit 121 determines the upper left region to be the temporal predictive motion vector information extraction region when the plurality of largest regions is present in the divided regions where all the regions are encoded by intra prediction and have no motion vector information. That is, the motion vector information of the upper left region (the co-located region) is used as the temporal predictive motion vector information.

Note that the temporal predictive motion vector information determination unit 121 performs the process of determining the temporal predictive motion vector information extraction region (hereinafter referred to as a temporal predictive motion vector information extraction region determination process) independently on each of L0 prediction and L1 prediction.

The temporal predictive motion vector information extraction region determination process performed by the temporal predictive motion vector information determination unit 121 in such manner becomes notably effective as the size of the current region increases. In other words, the process is less effective as the size of the current region decreases because the size of the current region comes close to the size of the upper left region, causing the motion vector information of the regions to have high correlation with each other. Therefore, the temporal predictive motion vector information extraction region determination process performed when the current region is small is not as effective considering the time required in the process.

Accordingly, the temporal predictive motion vector information determination unit 121 in the present embodiment performs the temporal predictive motion vector information extraction region determination process only when the size of the current region is equal to a predetermined threshold or larger. On the other hand, the temporal predictive motion vector information determination unit 121 determines the upper left region to be the temporal predictive motion vector information extraction region when the size of the current region is smaller than the predetermined threshold.

Note that the predetermined threshold for the size of the current region is specified in a sequence parameter set, a picture parameter set, or a slice header included in image compression information to be the input.

### [Motion Prediction/Compensation Unit, Temporal Predictive Motion Vector Information Determination Unit, and Motion Vector Encoding Unit]

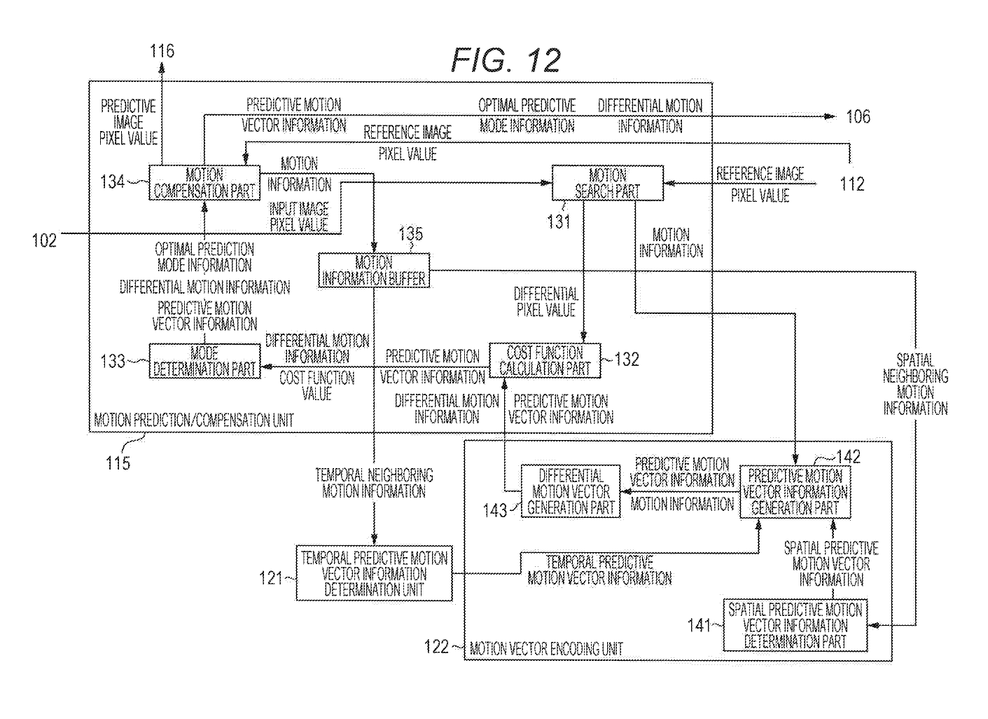

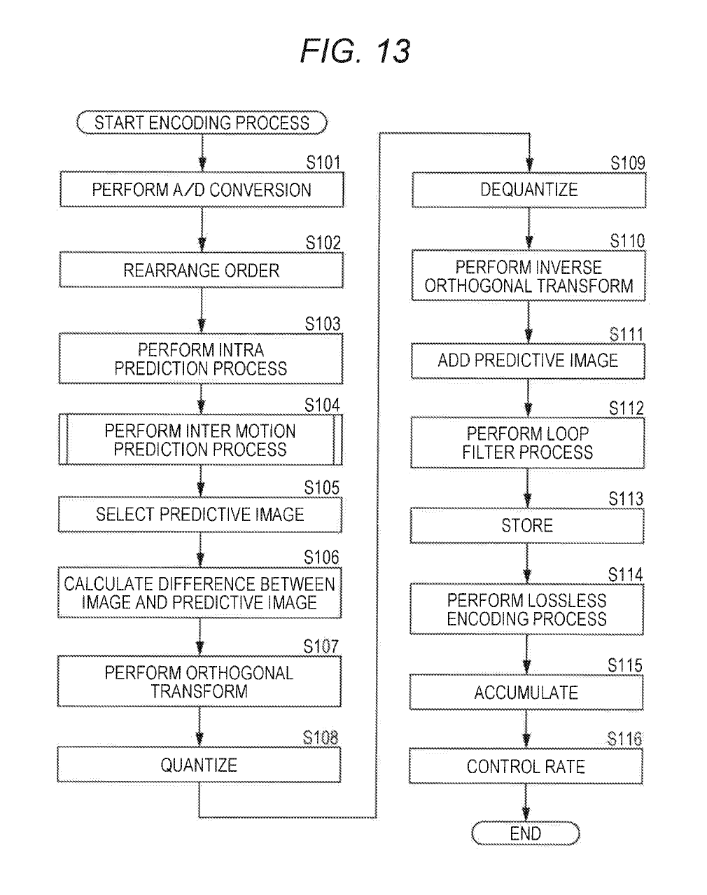

FIG. 12 is a block diagram illustrating an example of a detailed configuration of the motion prediction/compensation unit 115, the temporal predictive motion vector information determination unit 121, and the motion vector encoding unit 122 that are included in the image encoding device illustrated in FIG. 1.

As illustrated in FIG. 12, the motion prediction/compensation unit 115 includes a motion search part 131, a cost function calculation part 132, a mode determination part 133, a motion compensation part 134, and a motion information buffer 135.

The motion vector encoding unit 122 includes a spatial predictive motion vector information determination part 141, a predictive motion vector information generation part 142, and a differential motion vector generation part 143.

An input image pixel value from the screen rearrangement buffer 102 as well as a reference image pixel value from the frame memory 112 are input to the motion search part 131. The motion search part 131 then performs a motion search process on all the inter prediction modes to generate motion information which includes a motion vector and a reference index. Thereafter, the motion search part 131 supplies the generated motion information to the predictive motion vector information generation part 142 of the motion vector encoding unit 122.

The motion information buffer 135 stores the motion information of the region processed in the past in the optimal prediction mode. The stored motion information is supplied to each part as neighboring motion information in the process performed on the region that is processed temporally after the region corresponding to the stored motion information. In particular, the motion information buffer 135 supplies the temporal neighboring motion information to the temporal predictive motion vector information determination unit 121 and supplies the spatial neighboring motion information to the spatial predictive motion vector information determination part 141.

The temporal predictive motion vector information determination unit 121 performs the temporal predictive motion vector information extraction region determination process after acquiring the temporal neighboring motion information of each divided region included in the reference region from the motion information buffer 135. That is, the temporal predictive motion vector information determination unit 121 determines the largest region among the divided regions included in the reference region to be the temporal predictive motion vector information extraction region as described with reference to FIG. 11. As a result, the motion vector information (or the temporal neighboring motion information) of the temporal predictive motion vector information extraction region (the co-located region) is used as the temporal predictive motion vector information. The temporal predictive motion vector information determination unit 121 supplies the motion vector information of the determined temporal predictive motion vector information extraction region to the predictive motion vector information generation part 142 as the temporal predictive motion vector information.

Upon acquiring the spatial neighboring motion information from the motion information buffer 135, the spatial predictive motion vector information determination part 141 uses the cost function value to determine which of the spatial neighboring motion information is optimally used as the spatial predictive motion vector information. Here, the spatial predictive motion vector information determination part 141 generates the spatial predictive motion vector information from the spatial neighboring motion information having the smallest cost function value, and supplies the generated information to the predictive motion vector information generation part 142.

The predictive motion vector information generation part 142 acquires the temporal predictive motion vector information from the temporal predictive motion vector information determination unit 121 and the spatial predictive motion vector information from the spatial predictive motion vector information determination part 141. The predictive motion vector information generation part 142 then determines, for each inter prediction mode, the optimal predictive motion vector information from the temporal predictive motion vector information and the spatial predictive motion vector information that have been supplied.

The predictive motion vector information generation part 142 supplies the motion information acquired from the motion search part 131 and the predictive motion vector information having been determined to the differential motion vector generation part 143.

The differential motion vector generation part 143 generates, for each inter prediction mode, the differential motion information including the differential value between the motion information and the predictive motion vector information supplied from the predictive motion vector information generation part 142. The differential motion vector generation part 143 supplies the differential motion information generated for each inter prediction mode and the predictive motion vector information for each inter prediction mode to the cost function calculation part 132 of the motion prediction/compensation unit 115.

The motion search part 131 also uses the searched motion vector information to perform a compensation process on the reference image and generate a predictive image. Furthermore, the motion search part 131 calculates a difference (a differential pixel value) between the generated predictive image and the input image and supplies the calculated differential pixel value to the cost function calculation part 132.

The cost function calculation part 132 uses the differential pixel value supplied from the motion search part 131 for each inter prediction mode to calculate a cost function value in each inter prediction mode. The cost function calculation part 132 then supplies the cost function value calculated for each inter prediction mode to the mode determination part 133. The cost function calculation part 132 also supplies to the mode determination part 133 the differential motion information for each inter prediction mode and the predictive motion vector information for each inter prediction mode.

The mode determination part 133 determines which of the inter prediction modes is optimal for use by using the cost function value for each inter prediction mode and determines the inter prediction mode with the smallest cost function value to be the optimal prediction mode. The mode determination part 133 then supplies optimal prediction mode information that is the information on the optimal prediction mode and the merge information to the motion compensation part 134. The mode determination part 133 also supplies to the motion compensation part 134 the differential motion information and the predictive motion vector information for the inter prediction mode that has been selected as the optimal prediction mode.

The motion compensation part 134 uses the differential motion information and the predictive motion vector in supplied from the mode determination part 133 to generate the motion vector for the optimal prediction mode. The motion compensation part 134 generates the predictive image in the optimal prediction mode by using the motion vector and performing compensation on the reference image from the frame memory 112. The motion compensation part 134 supplies the generated predictive image to the predictive image selection unit 116.

The predictive image selection unit 116 supplies a signal indicating that the inter prediction has been selected by the predictive image selection unit 116, when the inter prediction has been selected. In response, the motion compensation part 134 supplies the optimal prediction mode information and the merge information to the lossless encoding unit 106. The motion compensation part 134 also supplies the differential motion information and the predictive motion vector information of the optimal prediction mode to the lossless encoding unit 106. Note that the predictive motion vector information of the optimal prediction mode supplied to the lossless encoding unit 106 includes identification information indicating which of the temporal predictive motion vector information and the spatial predictive motion vector information is used as the predictive motion vector information.

The motion compensation part 134 further stores the motion information in the optimal prediction mode into the motion information buffer 135. Note that 0 vector as the motion vector information is stored in the motion information buffer 135 when the inter prediction has not been selected by the predictive image selection unit 116 (meaning that an intra predictive image has been selected).

The motion information buffer 135 stores the motion information of the region processed in the past in the optimal prediction mode. As described above, the motion information buffer 135 supplies the temporal neighboring motion information to the temporal predictive motion vector information determination unit 121 and supplies the spatial neighboring motion information to the spatial predictive motion vector information determination part 141.

### [Encoding Process Flow]

Each process flow performed by the aforementioned image encoding device 100 will now be described.

FIG. 13 is a flowchart illustrating the flow of an encoding process.

The A/D conversion unit 101 performs A/D conversion on an input image in step S101. In step S102, the screen rearrangement buffer 102 stores the A/D-converted image and rearranges the order of each picture from the order of display to the order of encoding.

In step S103, the intra prediction unit 114 performs an intra prediction process in the intra prediction mode.

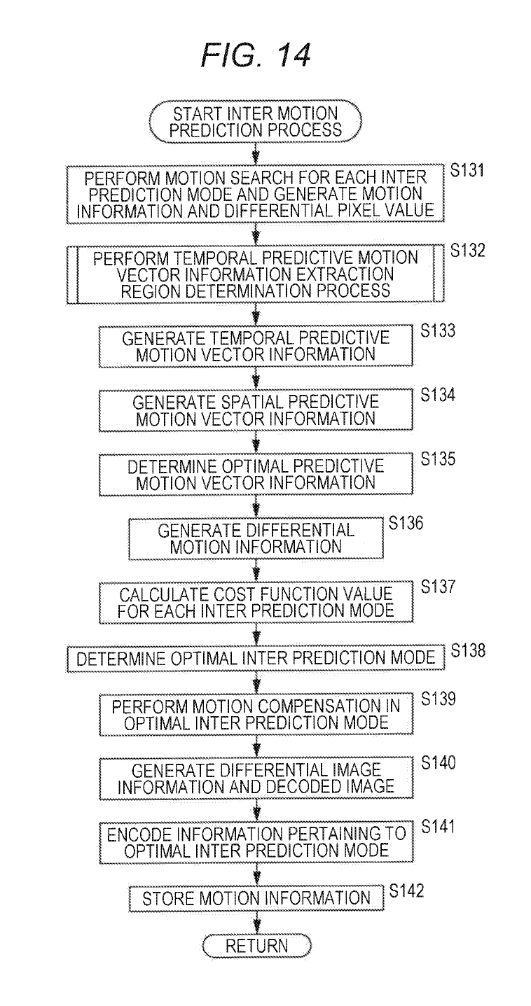

In step S104, the motion prediction/compensation unit 115 performs an inter motion prediction process which performs motion prediction or motion compensation in the inter prediction mode. Note that the detailed description of the process performed in step S104 will be given later with reference to FIG. 14.

In step S105, the predictive image selection unit 116 determines the optimal mode on the basis of each cost function value output from the intra prediction unit 114 and the motion prediction/compensation unit 115. That is the predictive image selection unit 116 selects either one of the predictive image generated by the intra prediction unit 114 or the predictive image generated by the motion prediction/compensation unit 115.

In step S106, the calculator 103 calculates the difference between the image rearranged in the process performed in step S102 and the predictive image selected by the process performed in step S105. The differential data has reduced data amount compared to the original image data. The data amount can therefore be compressed as compared to when the image is encoded as is.

In step S107, the orthogonal transform unit 104 performs an orthogonal transform on the differential information generated by the process performed in step S106. Specifically, the orthogonal, transform such as the discrete cosine transform or the Karhunen-Loeve transform is performed so that a transform coefficient is output.

In step S108, the quantization unit 105 quantizes the orthogonal transform coefficient obtained by the process performed in step S107.

The differential information quantized by the process performed in step S108 is decoded locally as follows. That is, in step S109, the dequantization unit 108 dequantizes the orthogonal transform coefficient (also referred to as a quantized coefficient) that is quantized and generated by the process performed, in step S108 by a characteristic corresponding to the characteristic of the quantization unit 105.

In step S110, the inverse orthogonal transform unit 109 performs an inverse orthogonal transform on the orthogonal transform coefficient obtained by the process performed in step S107 by a characteristic corresponding to the characteristic of the orthogonal transform unit 104.

In step S111, the calculator 110 generates a locally-decoded image (an image corresponding to the input to the calculator 103) by adding the predictive image to the locally-decoded differential information.

In step S112, the loop filter 111 performs a loop filter process including a deblocking filter process and an adaptive loop filter process, as appropriate, on the locally-decoded image obtained by the process performed in step S111.

In step S113, the frame memory 112 stores the decoded image on which the loop filter process has been performed by the process performed in step S112. The frame memory 112 also stores an image on which the filter process has not been performed by the loop filter 111, the image being supplied from the calculator 110.

In step S114, the lossless encoding unit 106 encodes the transform coefficient quantized by the process performed in step S108. That is, the lossless encoding such as variable length encoding or arithmetic encoding is performed on the differential image.

The lossless encoding unit 106 encodes the quantized parameter calculated in step S108 and adds it to the encoded data. The lossless encoding unit 106 further encodes the information on the prediction mode of the predictive image selected by the process performed in step S105 and adds it to the encoded data obtained by encoding the differential image. The lossless encoding unit 106 further encodes the optimal intra prediction mode information supplied from the intra prediction unit 114 or the information corresponding to the optimal inter prediction mode supplied from the motion prediction/compensation unit 115, and adds it to the encoded data.

In step S115, the accumulation buffer 107 accumulates the encoded data obtained by the process performed in step S114. The encoded data accumulated in the accumulation buffer 107 is read out as appropriate and transmitted to the decoding side through a transmission path and a recording medium.

In step S116, the rate control unit 117 controls the rate of quantization operation by the quantization unit 105 on the basis of the code amount (generated code amount) of the encoded data accumulated in the accumulation buffer 107 by the process performed in step S115, in order not to cause overflow or underfloor.

The encoding process is now completed.

### [Flow of Inter Motion Prediction Process]

Now, the inter motion prediction process performed in step S104 of FIG. 13 will be described.

FIG. 14 is a flowchart illustrating the flow of the inter motion prediction process.

In step S131, the motion search part 131 performs motion search in each inter prediction mode and generates the motion information and the differential pixel value.

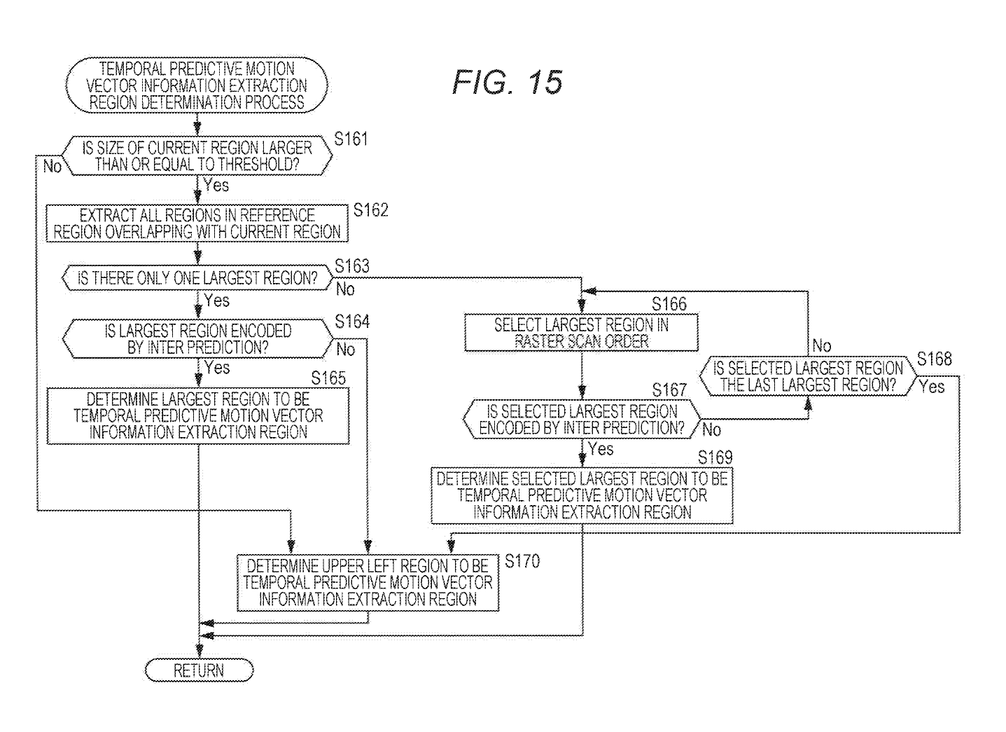

In step S132, the temporal predictive motion vector information determination unit 121 performs the temporal predictive motion vector information extraction region determination process, in which the largest region among the divided regions included in the reference region is determined to be the temporal predictive motion vector information extraction region. Note that the process performed in step S132 will be described later with reference to FIG. 15.

In step S133, the temporal predictive motion vector information determination unit 121 generates the temporal predictive motion vector information. That is the temporal predictive motion vector information determination unit 121 determines the motion vector information of the temporal predictive motion vector information extraction region determined in step S132 to be the temporal predictive motion vector information.

In step S134, the spatial predictive motion vector information determination part 141 generates the spatial predictive motion vector information from the spatial neighboring motion information having the smallest cost function value among the spatial neighboring motion information supplied from the motion information buffer 135.

In step S135, the predictive motion vector information generation part 142 determines the optimal predictive motion vector information from among the temporal predictive motion vector information and the spatial predictive motion vector information generated in step S133 and step S134, respectively.

In step S136, the differential motion vector generation part 143 generates the differential motion information including the differential value between the motion information and the optimal predictive motion vector information determined in step S135.

In step S137, the cost function calculation part 132 calculates the cost function value for each inter prediction mode.

In step S138, the mode determination part 133 uses the cost function value calculated in step S137 to determine the optimal inter prediction mode (also referred to as the optimal prediction mode) that is the inter prediction mode determined to be the optimal.

In step S139, the motion compensation part 134 performs motion compensation in the optimal inter prediction mode.

In step S140, the motion compensation part 134 supplies the predictive image obtained by the motion compensation performed in step S139 to the calculator 103 and the calculator 110 through the predictive image selection unit 116, and generates the differential image information and the decoded image.

In step S141, the motion compensation part 134 supplies the optimal prediction mode information, the differential motion information, and the predictive motion vector information to the lossless encoding unit 106, which then encodes the supplied information.

In step S142, the motion information buffer 135 stores the motion information of the optimal inter prediction mode selected.

The inter motion prediction process is now completed, and the process goes back to FIG. 13.

### [Flow of Temporal Predictive Motion Vector Information Extraction Region Determination Process]

Now, the temporal predictive motion vector information extraction region determination process performed in step S132 of FIG. 14 will be described.

FIG. 15 is a flowchart illustrating the flow of the temporal predictive motion vector information extraction region determination process.

In step S161, the temporal predictive motion vector information determination unit 121 determines whether the size of the current region is equal to a threshold or larger.

It is determined YES in step S161 when the size of the current region is equal to the threshold or larger, whereby the process proceeds to step S162. Note that the process performed after step S162 will be described later.

On the other hand, it is determined NO in step S161 when the size of the current region is smaller than the threshold, whereby the process proceeds to step S170.

In step S170, the temporal predictive motion vector information determination unit 121 determines the upper left region to be the temporal predictive motion vector information extraction region. That is, the motion vector information of the upper left region (the co-located region) is used as the temporal predictive motion vector information. This completes the temporal predictive motion vector information extraction region determination process, and the process goes back to FIG. 14.

On the other hand, it is determined YES in step S161 when the size of the current region is equal to the threshold or larger, whereby the process proceeds to step S162.

In step S162, the temporal predictive motion vector information determination unit 121 extracts all regions overlapping with the current region from the reference region. That is, the temporal predictive motion vector information determination unit 121 extracts all the divided regions in the reference region.

In step S163, the temporal predictive motion vector information determination unit 121 determines whether there is one largest region. In other words, the temporal predictive motion vector information determination unit 121 determines, from among the divided regions included in the reference region, whether there is only one region having the largest area of overlap with the current region.

It is determined NO in step S163 when the number of largest regions is not one, whereby the process proceeds to step S166. Note that the process performed after step S163 will be described later.

On the other hand, it is determined YES in step S163 when there is one largest region present, whereby the process proceeds to step S164.

In step S164, the temporal predictive motion vector information determination unit 121 determines whether the largest region is the region encoded by inter prediction.

It is determined YES in step S164 when the largest region is the region encoded by inter prediction, whereby the process proceeds to step 165.

In step S165, the temporal predictive motion vector information determination unit 121 determines the largest region to be the temporal predictive motion vector information extraction region. This means that the motion vector information of the largest region (the co-located region) is used as the temporal predictive motion vector information. This completes the temporal predictive motion vector information extraction region determination process, and the process goes back to FIG. 14.

On the other hand, it is determined NO in step S164 when the largest region is determined to be not the region encoded by inter prediction, namely, the largest region is the region encoded by intra prediction, whereby the process proceeds to step S170.

In step S170, the temporal predictive motion vector information determination unit 121 determines the upper left region to be the temporal predictive motion vector information extraction region. This completes the temporal predictive motion vector information extraction region determination process, and the process goes back to FIG. 14.

On the other hand, it is determined NO in step S163 when the number of largest regions is not one, whereby the process proceeds to step S166.

In step S166, the temporal predictive motion vector information determination unit 121 selects the largest region appearing first when the divided region is traced in the order it is raster-scanned.

In step S167, the temporal predictive motion vector information determination unit 121 determines whether the selected largest region is the region encoded by inter prediction.

It is determined NO when the largest region is determined to be not the region encoded by inter prediction, namely, when the largest region is the region encoded by intra prediction, whereby the process proceeds to step S168,

In step S168, the temporal predictive motion vector information determination unit 121 determines whether the selected largest region is the last largest region among the plurality of largest regions. That is, the temporal predictive motion vector information determination unit 121 determines whether the selected largest region is the largest region appearing last when the divided region is traced in the order it is raster-scanned.

It is determined NO in step S168 when the selected largest region is not the last largest region, whereby the process goes back to step S166, and the process performed from there on is repeated. That is, the loop process between step S166 and S168 is repeated until the region encoded by inter prediction is selected as the largest region or the last largest region encoded by intra prediction is selected.

Subsequently, the second largest region in the raster scan order is selected in step S166. In step S167, it is determined YES when the selected largest region is the region encoded by inter prediction, and the process proceeds to step S169.

In step S169, the temporal predictive motion vector information determination unit 121 determines the selected largest region to be the temporal predictive motion vector information extraction region. The motion vector information of the selected largest region (the co-located region) is used as the temporal predictive motion vector information as a result. This completes the temporal predictive motion vector information extraction region determination process, and the process goes back to FIG. 14.

On the other hand, the process proceeds to step S168 when the second largest region in the raster-scan order is selected in step S166 and, in step S167, it is determined NO because the selected largest region is not the region encoded by inter prediction.

In step S168, it is determined YES when the selected largest region is the last largest region, whereby the process proceeds to step S170.

In step S170, the temporal predictive motion vector information determination unit 121 determines the upper left region to be the temporal predictive motion vector information extraction region. This completes the temporal predictive motion vector information extraction region determination, process, and the process goes back to FIG. 14.

Subsequently, the temporal predictive motion vector information of the temporal predictive motion vector information extraction region is generated in step S133 of FIG. 14, and the spatial predictive motion vector information is generated in step S134. In step S135, the optimal predictive motion vector information is determined from the generated temporal predictive motion vector information and spatial predictive motion vector information.

As a result, the temporal predictive motion vector information determination unit 121 can supply to the motion vector encoding unit 122 the temporal predictive motion vector information having high correlation with the motion vector information of the current region. The motion vector encoding unit 122 can therefore use the temporal predictive motion vector information as the predictive motion vector information and reduce the amount of information on the predictive motion vector, the temporal predictive motion vector information having high correlation with the motion vector information of the current region. Accordingly, the image encoding device 100 can improve the efficiency of encoding the motion vector.

The temporal predictive motion vector information extraction region determination process is performed in the aforementioned example under the condition that the size of the current region is equal to or larger than the predetermined threshold. However, the condition on which the temporal predictive motion vector information extraction region determination process is performed is not limited to what is described in the aforementioned example. For example, one may adopt a condition that the profile level (such as a picture frame) in the image compression information to be the output is higher than a certain level specified. This is because the larger the size of the picture frame, the larger the CU or the PU used more likely in the encoding process whereas the smaller the size of the picture frame, the smaller the CU or the PU used more likely in the encoding process, whereby one can achieve greater improvement when the temporal predictive motion vector information extraction region determination process is performed with the larger picture frame. It is particularly effective to apply the temporal predictive motion vector information extraction region determination process to an HD (High Definition) image having 1920×1080 pixels and a sequence having a higher resolution. Note that the temporal predictive motion vector information extraction region determination process may be performed regardless of the size of the current region and the profile level. That is, the two aforementioned conditions on which the temporal predictive motion vector information extraction region determination process is performed need not be the mandatory condition.

Moreover, in addition to the motion vector of the neighboring region adjacent above or to the left of the current region, the motion vector of the co-located region (or the temporal predictive motion vector information extraction region) according to the present embodiment can be added as the motion vector of the neighboring region to be compared with the motion vector of the current region in the merge mode.

### 2. Second Embodiment

### Image Decoding Device

A process of decoding the data encoded in the aforementioned manner will now be described.

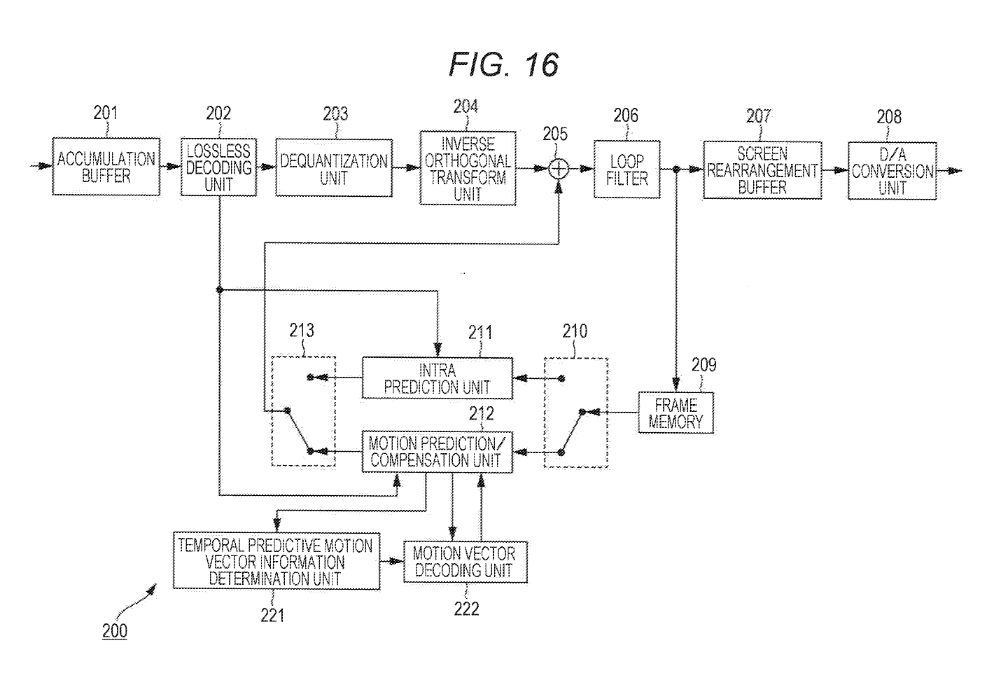

FIG. 16 is a block diagram illustrating an example of a main configuration of an image decoding device corresponding to the image encoding device 100 illustrated in FIG. 1.

An image decoding device 200 illustrated in FIG. 16 decodes encoded data generated by the image encoding device 100 by a decoding method corresponding to the encoding method. Note that, as with the image encoding device 100, the image decoding device 200 is adapted to perform inter prediction by the unit of prediction unit (PU).

The image decoding device 200 illustrated in FIG. 16 includes an accumulation buffer 201, a lossless decoding unit 202, a dequantization unit 203, an inverse orthogonal transform unit 204, a calculator 205, a loop filter 206, a screen rearrangement buffer 207, and a D/A conversion unit 208. Further, the image decoding device 200 includes a frame memory 209, a selection unit 210, an intra prediction unit 211, a motion prediction/compensation unit 212, and a selection unit 213.

The image decoding device 200 further includes a temporal predictive motion vector information determination unit 221 and a motion vector decoding unit 222.

The accumulation buffer 201 accumulates encoded data that is transmitted and supplies the encoded data to the lossless decoding unit 202 at a predetermined timing. The lossless decoding unit 202 decodes information, which is encoded by a lossless encoding unit 106 illustrated in FIG. 1 and supplied from the accumulation buffer 201, by a decoding scheme corresponding to an encoding scheme employed by the lossless encoding unit 106. The lossless decoding unit 202 supplies quantized coefficient data of a differential image obtained by decoding, to the dequantization unit 203.

The lossless decoding unit 202 also determines whether an intra prediction mode or an inter prediction mode has been selected as the optimal prediction mode, and supplies information on the optimal prediction mode to either the intra prediction unit 211 or the motion prediction/compensation unit 212 corresponding to the mode that, the lossless decoding unit has determined, has been selected. For example, the information on the optimal prediction mode is supplied to the motion prediction/compensation unit 212 when the image encoding device 100 has determined the inter prediction mode as the optimal prediction mode.

The dequantization unit 203 dequantizes the quantized coefficient data decoded by the lossless decoding unit 202 by a scheme corresponding to the quantization scheme employed by a quantization unit 105 illustrated in FIG. 1, and supplies the coefficient data obtained to the inverse orthogonal transform unit 204.

The inverse orthogonal transform unit 204 performs an inverse orthogonal transform on the coefficient data supplied from the dequantization unit 203 by a scheme corresponding to an orthogonal transform scheme employed by an orthogonal transform unit 104 illustrated in FIG. 1. As a result of the inverse orthogonal transform process, the inverse orthogonal transform unit 204 obtains decoded residual data corresponding to residual data before subjected to the orthogonal transform by the image encoding device 100.

The decoded residual data that has undergone the inverse orthogonal transform is supplied to the calculator 205. A predictive image from the intra prediction unit 211 or the motion prediction/compensation unit 212 is also supplied to the calculator 205 through the selection unit 213.

The calculator 205 adds the decoded residual data and the predictive image together and obtains decoded image data corresponding to image data before subtracting therefrom the predictive image by a calculator 103 in the image encoding device 100. The calculator 205 then supplies the decoded image data to the loop filter 206.

The loop filter 206 appropriately performs a loop filter process including a deblocking filter process and an adaptive loop filter process on the decoded image supplied and supplies the outcome to the screen rearrangement buffer 207.

The loop filter 206 including a deblocking filter and an adaptive loop filter performs the filter process on the decoded image supplied from the calculator 205 as deemed appropriate. For example, the loop filter 206 removes block distortion in the decoded image by performing the deblocking filter process on the decoded image. The loop filter 206 also improves image quality by performing the loop filter process on the outcome of the deblocking filter process (the decoded image from which the block distortion has been removed) by using a Wiener Filter, for example.

Note that the loop filter 206 may be adapted to perform an arbitrary filter process on the decoded image. The loop filter 206 may also perform the filter process by using a filter coefficient supplied from the image encoding device 100 illustrated in FIG. 1.

The loop filter 206 supplies the outcome of the filter process (the decoded image following the filter process) to the screen rearrangement buffer 207 and the frame memory 209. The decoded image output from the calculator 205 can be supplied to the screen rearrangement buffer 207 and the frame memory 209 without passing through the loop filter 206, meaning that the filter process performed by the loop filter 206 can be omitted.

The screen rearrangement buffer 207 rearranges the image. That is, the order of frames rearranged into the encoding order by a screen rearrangement buffer 102 illustrated in FIG. 1 is now rearranged back into the original order of display. The D/A conversion unit 208 performs D/A conversion on the image supplied from the screen rearrangement buffer 207 and outputs it to a display (not shown) on which the supplied image is displayed.

The frame memory 209 stores the decoded image supplied thereto and supplies the stored decoded image to the selection unit 210 as a reference image at a predetermined timing or on the basis of a request from outside such as the intra prediction unit 211 or the motion prediction/compensation unit 212.

The selection unit 210 selects a destination to which the reference image supplied from the frame memory 209 is supplied. The selection unit 210 supplies the reference image supplied from the frame memory 209 to the intra prediction unit 211 when decoding an intra-encoded image. On the other hand, the selection unit 210 supplies the reference image supplied from the frame memory 209 to the motion prediction/compensation unit 212 when decoding an inter-encoded image.

The lossless decoding unit 202 supplies information representing an intra prediction mode obtained by decoding header information to the intra prediction unit 211, as deemed appropriate. The intra prediction unit 211 performs intra prediction by using the reference image acquired from the frame memory 209 and generates a predictive image in the intra prediction mode used in an intra prediction unit 114 illustrated in FIG. 1. The intra prediction unit 211 thereafter supplies the generated predictive image to the selection unit 213,

The motion prediction/compensation unit 212 acquires from the lossless decoding unit 202 the information obtained by decoding the header information (such as optimal prediction mode information and differential information).

The motion prediction/compensation unit 212 performs inter prediction by using the reference image acquired from the frame memory 209 and generates a predictive image in the inter prediction mode used in a motion prediction/compensation unit 115 illustrated in FIG. 1.

The motion prediction/compensation unit 212 also supplies temporal predictive motion vector information to the temporal predictive motion vector information determination unit 221 when the temporal predictive motion vector information is used as the motion vector information in the optimal prediction mode. On the other hand, the motion prediction/compensation unit 212 supplies spatial predictive motion vector information to the motion vector decoding unit 222 when the spatial predictive motion vector information is used as the motion vector information in the optimal prediction mode.

Upon receiving the temporal predictive motion vector information supplied from the motion prediction/compensation unit 212, the temporal predictive motion vector information determination unit 221 performs the process basically similar to that performed by the temporal predictive motion vector information determination unit 121. The temporal predictive motion vector information determination unit 221 then reconstructs the temporal predictive motion vector information and supplies the reconstructed temporal predictive motion vector information to the motion vector decoding unit 222.

The motion vector decoding unit 222 reconstructs the spatial predictive motion vector information upon receiving it from the motion prediction/compensation unit 212. The motion vector decoding unit 222 then supplies the temporal predictive motion vector information reconstructed by the temporal predictive motion vector information determination unit 221 or the reconstructed temporal predictive motion vector information to the motion prediction/compensation unit 212 as the predictive motion vector information.

### [Motion Prediction/Compensation Unit, Temporal Predictive Motion Vector Information Determination Unit, and Motion Vector Decoding Unit]

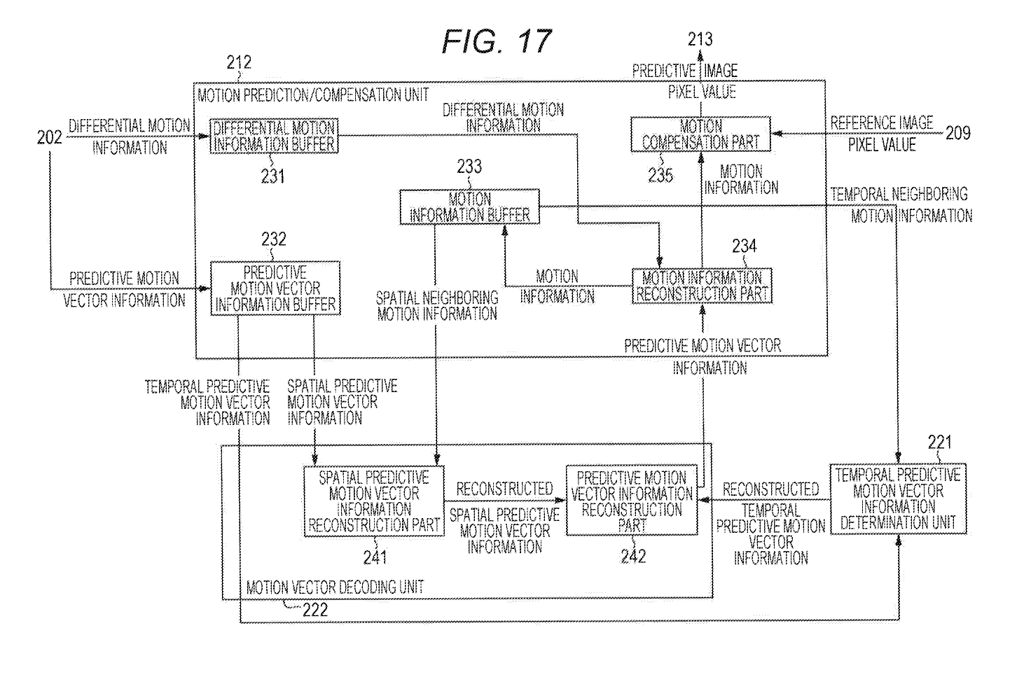

FIG. 17 is a block diagram illustrating an example of a detailed configuration of the motion prediction/compensation unit 212, the temporal predictive motion vector information determination unit 221, and the motion vector decoding unit 222.

As illustrated in FIG. 17, the motion prediction/compensation unit 212 includes a differential motion information buffer 231, a predictive motion vector information buffer 232, a motion information buffer 233, a motion information reconstruction part 234, a motion compensation part 235, and a motion compensation part 236.

The motion vector decoding unit 222 includes a spatial predictive motion vector information reconstruction part 241 and a predictive motion vector information reconstruction part 242.

The differential motion information buffer 231 stores the differential motion information supplied from the lossless decoding unit 202. Supplied from the image encoding device 100, this differential motion information is the differential motion information of the inter prediction mode that is selected to be the optimal prediction mode (namely, the difference between the predictive motion vector information and the motion information). The differential motion information buffer 231 supplies the stored differential motion information to the motion information reconstruction part 234 at a predetermined timing or on the basis of a request sent from the motion information reconstruction part 234.

The predictive motion vector information buffer 232 stores the predictive motion vector information supplied from the lossless decoding unit 202. Supplied from the image encoding device 100, this predictive motion vector information is the predictive motion vector information of the inter prediction mode that is selected to be the optimal prediction mode. The predictive motion vector information buffer 232 supplies the predictive motion vector information stored therein to the spatial predictive motion vector information reconstruction part 241 or the temporal predictive motion vector information determination unit 221 at a predetermined timing or on the basis of a request from the spatial predictive motion vector information reconstruction part 241 or the temporal predictive motion vector information determination unit 221. In particular, the predictive motion vector information buffer 232 supplies the temporal predictive motion vector information to the temporal predictive motion vector information determination unit 221 when the temporal predictive motion vector information is used as the predictive motion vector information of the optimal prediction mode. On the other hand, the predictive motion vector information buffer 232 supplies the spatial predictive motion vector information to the spatial predictive motion vector information reconstruction part 241 when the spatial predictive motion vector information is used as the predictive motion vector information of the optimal prediction mode.

The motion information buffer 233 stores the motion information of the current region supplied from the motion information reconstruction part 234. The motion information buffer 233 supplies, to the spatial predictive motion vector information reconstruction part 241 and the temporal predictive motion vector information determination unit 221, motion information obtained in a process performed on another region that is processed temporally after the current region as neighboring motion information. In particular, the motion information buffer 233 supplies the temporal neighboring motion information to the temporal predictive motion vector information determination unit 221 on the basis of the request from the temporal predictive motion vector information determination unit 221. The motion information buffer 233 further supplies the spatial neighboring motion information to the spatial predictive motion vector information reconstruction part 241 on the basis of the request from the spatial predictive motion vector information reconstruction part 241.

Upon receiving the temporal predictive motion vector information supplied from the predictive motion vector information buffer 232, the temporal predictive motion vector information determination unit 221 acquires the temporal neighboring motion information from the motion information buffer 233 and performs the temporal predictive motion vector information extraction region determination process. In other words, the temporal predictive motion vector information determination unit 221 determines the largest region among the divided regions included in the reference region to be the temporal predictive motion vector information extraction region (the co-located region). The temporal predictive motion vector information determination unit 221 then reconstructs the temporal predictive motion vector information of the temporal predictive motion vector information extraction region having been determined, and supplies the reconstructed temporal predictive motion vector information to the predictive motion vector information reconstruction part 242.

Upon receiving the spatial predictive motion vector information supplied from the predictive motion vector information buffer 232, the spatial predictive motion vector information reconstruction part 241 acquires the spatial neighboring motion information from the motion information buffer 233 and reconstructs the spatial predictive motion vector information. The spatial predictive motion vector information reconstruction 241 then supplies the reconstructed predictive motion vector information to the predictive motion vector information reconstruction part 242.

The predictive motion vector information reconstruction part 242 acquires the temporal predictive motion vector information reconstructed by the temporal predictive motion vector information determination unit 221 or the spatial predictive motion vector information reconstructed by the spatial predictive motion vector information reconstruction part 241 and supplies the acquired information to the motion information reconstruction part 234 of the motion prediction/compensation unit 212 as the predictive motion vector information.

The motion information reconstruction part 234 acquires from the differential motion information buffer 231 the differential motion information supplied from the image encoding device 100. The motion information reconstruction part 234 then adds the predictive motion vector information (the temporal predictive motion vector information or the spatial predictive motion vector information) acquired from the predictive motion vector information reconstruction part 242 to the acquired differential motion information, and reconstructs the motion information of the current region. The motion information reconstruction part 234 supplies the reconstructed motion information of the current region to the motion compensation part 235.

The motion compensation part 235 uses the motion information of the current region reconstructed by the motion information reconstruction part 234 as described above to perform motion compensation on the reference image pixel value acquired from the frame memory 209 and generate the predictive image. The motion compensation part 235 supplies the predictive image pixel value to the calculator 205 through the selection unit 213.

The motion information reconstruction part 234 also supplies the reconstructed motion information of the current region to the motion information buffer 233.

The motion information buffer 233 stores the motion information of the current region supplied from the motion information reconstruction part 234. As described above, the motion information buffer 233 supplies, to the spatial predictive motion vector information reconstruction part 241 and the temporal predictive motion vector information determination unit 221, the motion information obtained in the process performed on another region that is processed temporally after the current region as the neighboring motion information.

Each part performs the process as described above, whereby the image decoding device 200 can correctly decode the data encoded by the image encoding device 100 and improve the encoding efficiency.

### [Decoding Process Flow]

The flow of each process performed by the aforementioned image decoding device 200 will now be described.

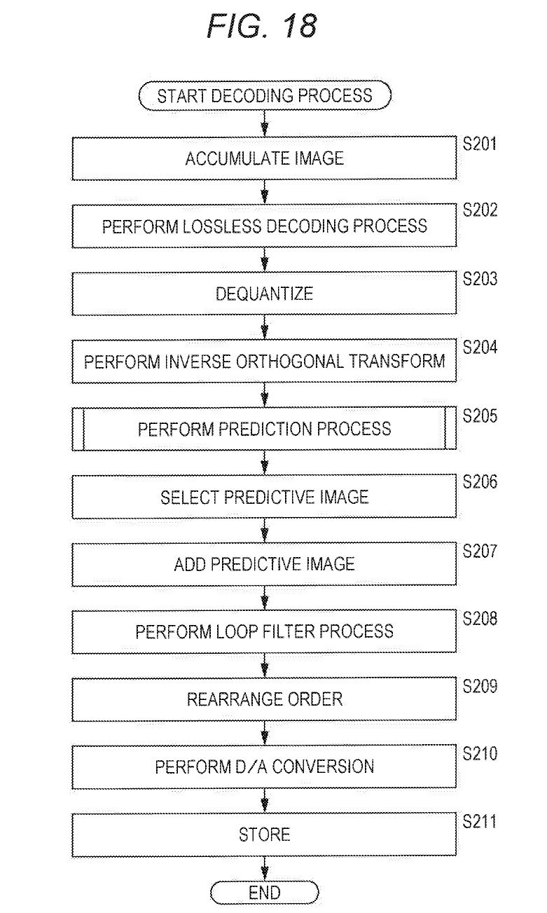

FIG. 18 is a flowchart illustrating the flow of a decoding process.

In step S201, the accumulation buffer 201 accumulates a code stream being transmitted (or encoded differential image information).

In step S202, the lossless decoding unit 202 decodes the code stream supplied from the accumulation buffer 201. That is the I picture, the P picture, and the B picture encoded by the lossless encoding unit 106 illustrated in FIG. 1 are decoded.

Also decoded at this time are various pieces of information such as the differential motion information and the predictive motion vector information in addition to the differential image information included in the code stream.

In step S203, the dequantization unit 203 dequantizes the quantized orthogonal transform coefficient, obtained by the process performed in step S202.

In step S204, the inverse orthogonal transform unit 204 performs an inverse orthogonal transform on the orthogonal transform coefficient dequantized in, step S203.

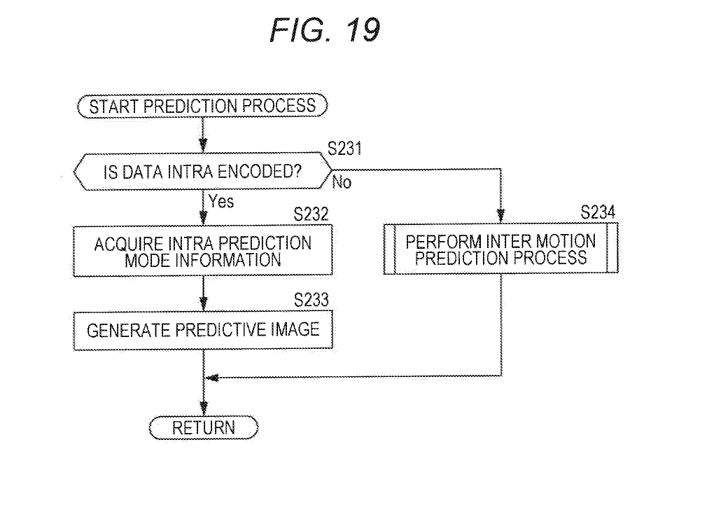

In step S205, the intra prediction unit 211 or the motion prediction/compensation unit 212 uses the information supplied to perform the prediction process. The detailed description of the process performed in step S205 will be provided later with reference to FIG. 19.

In step S206, the selection unit 213 selects the predictive image generated in step S205.

In step S207, the calculator 205 adds the predictive image selected in step S206 to the differential image information obtained by the inverse orthogonal transform performed in step S204. The original image is decoded as a result.

In step S208, the loop filter 206 appropriately performs a loop filter process including a deblocking filter process and an adaptive loop filter process on the decoded image obtained in step S207.

In step S209, the screen rearrangement buffer 207 rearranges the image on which the filter process has been performed in step S208. Namely, the order of frames rearranged for encoding by the screen rearrangement buffer 102 in the image encoding device 100 is rearranged back to the original, order of display.

In step S210, the D/A conversion unit 208 performs D/A conversion on the image, the frame order of which has been rearranged in step S209. This image is then output to a display (not shown) and displayed.

In step S211, the frame memory 209 stores the image on which the filter process has been performed in step S208.

The decoding process is now completed.

### [Prediction Process Flow]

Next, the prediction process performed in step S205 of FIG. 18 will be described.

FIG. 19 is a flowchart illustrating the flow of the prediction process.

In step S231, the lossless decoding unit 202 determines whether or not the encoded data to be processed is intra encoded on the basis of the information of the optimal prediction mode supplied from the image encoding device 100.

It is determined YES in step S231 when the encoded data is determined to be intra encoded, whereby the process proceeds to step S232.

In step S232, the intra prediction unit 211 acquires intra prediction, mode information.

In step S233, the intra prediction unit 211 uses the intra prediction mode information acquired in step S232 to perform intra prediction and generate the predictive image. The prediction process is completed when the predictive image has been generated, and the process goes back to FIG. 18.

On the other hand, it is determined NO in step S231 when the encoded data is determined to be inter encoded in step S231, whereby the process proceeds to step S234.

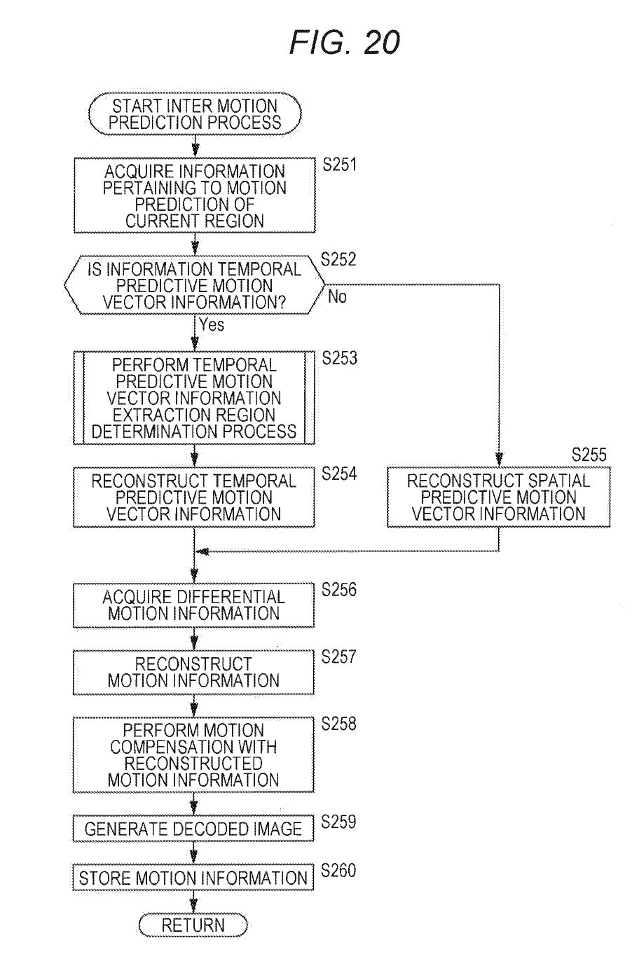

In step S234, the motion prediction/compensation unit 212 performs the inter motion prediction process. The detailed description of the process performed in step S234 will be provided later with reference to FIG. 20.

The prediction process is completed when the inter motion prediction process has been completed, and the process goes back to FIG. 18.

### [Flow of Inter Motion Prediction Process]

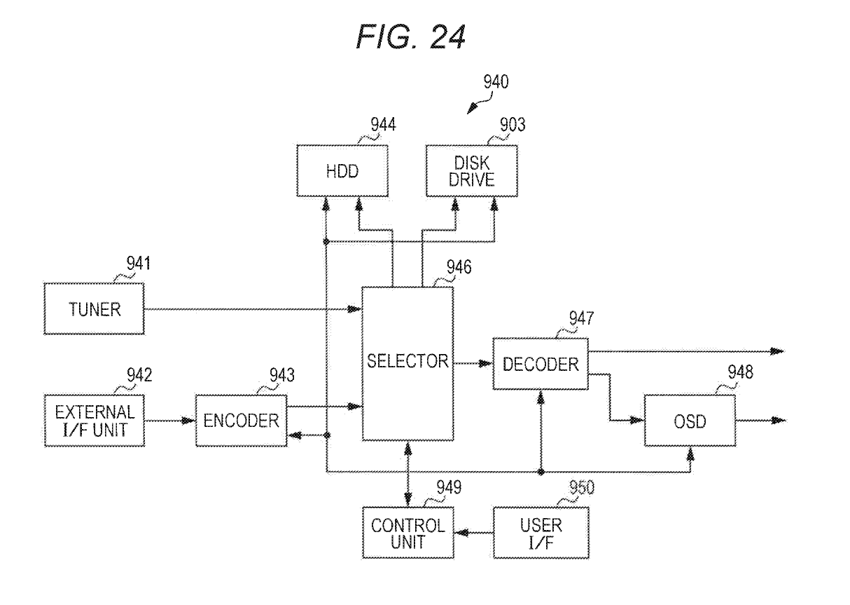

The inter motion prediction process performed in step S234 of FIG. 24 will now be described.

FIG. 20 is a flowchart illustrating the flow of the inter motion prediction process.

In step S251, the motion prediction/compensation unit 212 acquires information pertaining to the motion prediction performed on the current region. For example, the differential motion information buffer 231 acquires the differential motion information, and the predictive motion vector information buffer 232 acquires the predictive motion vector information.

In step S252, the predictive motion vector information buffer 232 determines whether the acquired predictive motion vector information is the temporal predictive motion vector information on the basis of the identification information included in the predictive motion vector information acquired in step S251.

It is determined YES in step S252 when the acquired predictive motion vector information is the temporal predictive motion vector information, and the process proceeds to step S253.

In step S253, the temporal predictive motion vector information determination unit 221 performs the temporal predictive motion vector information extraction region determination process. In other words, the temporal predictive motion vector information determination unit 221 determines the largest region among the divided regions included in the reference region to be the temporal predictive motion vector information extraction region (the co-located region). Here, the description of the temporal predictive motion vector information extraction region determination process similar to that in FIG. 15 will be omitted to avoid reiteration.

In step S254, the temporal predictive motion vector information determination unit 221 reconstructs the temporal predictive motion vector information. The process proceeds to step S256 once the temporal predictive motion vector information has been reconstructed. Note that the process following step S256 will be described later.

On the other hand, it is determined NO in step S252 when the acquired predictive motion vector information is the spatial predictive motion vector information, and the process proceeds to step S255.

In step S255, the spatial predictive motion vector information reconstruction part 241 reconstructs the spatial predictive motion vector information. The process proceeds to step S256 once the spatial predictive motion vector information has been reconstructed.

In step S256, the motion information reconstruction part 234 acquires the differential motion information from the differential motion information buffer 231.

In step S257, the motion information reconstruction part 234 adds the differential motion information acquired in step S256 to the temporal predictive motion vector information reconstructed in step S254 or the spatial predictive motion vector information reconstructed in step S255, thereby reconstructing the motion information of the current region.

In step S258, the motion compensation part 235 uses the motion information reconstructed in step S257 to perform the motion compensation and generate the predictive image.

In step S259, the motion compensation part 236 supplies the predictive image generated in step S258 to the calculator 205 through the selection unit 213 and generates the decoded image.

In step S260, the motion information buffer 233 stores the motion information reconstructed in step S257.

This completes the inter motion prediction process, and the process goes back to FIG. 19.

By performing each process in the aforementioned manner, the image decoding device 200 can correctly decode the encoded data that is encoded by the image encoding device 100. The image decoding device 200 can therefore improve the efficiency of encoding the motion vector, the encoding being performed by the image encoding device 100.

As with the MPEG and H.26x, for example, the present technique can be applied to an image encoding device and an image decoding device used in receiving image information (bit stream) compressed by the orthogonal transform such as the discrete cosine transform and the motion compensation through a network medium such as satellite broadcasting, cable television, Internet, or a mobile telephone. The present technique can also be applied to an image encoding device and an image decoding device used in performing a process on a storage medium such as an optical disk, a magnetic disk, or a flash memory. Furthermore, the present technique can be applied to a motion prediction compensation device included in these image encoding device and the image decoding device.

### 3. Third Embodiment

### Computer

The aforementioned series of processes can be executed by hardware or software. A program configuring the software is installed to a computer when the series of processes is executed by the software. The computer here includes a computer incorporated into dedicated hardware and a general-purpose personal computer capable of executing various functions by installing various programs.

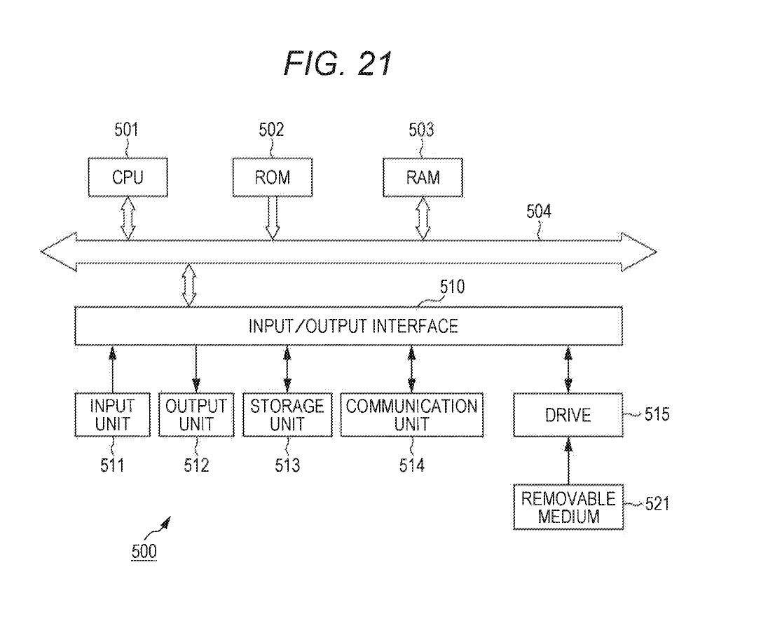

As illustrated in FIG. 21, a CPU (Central Processing Unit) 501 of a personal computer 500 executes various processes according to a program stored in a ROM (Read Only Memory) 502 or a program loaded to a RAM (Random Access Memory) 503 from a storage unit 513. The RAM 503 also stores data or the like necessary for the CPU 501 to execute the various processes, as deemed appropriate.

The CPU 501, the ROM 502, and the RAM 503 are connected to one another via a bus 504. An input/output interface 510 is also connected to the bus 504.

Connected to the input/output interface 510 are an input unit 511 including a keyboard and a mouse, an output unit 512 including a CRT (Cathode Ray Tube) or LCD (Liquid Crystal Display) display and a speaker, the storage unit 513 including a hard disk or the like, and a communication unit 514 including a modem or the like. The communication unit 514 performs a communication process through a network including Internet.

Moreover, a drive 515 is connected to the input/output interface 510 as needed while a removable medium 521 such as a magnetic disk, an optical disk, a magneto-optical disk, or a semiconductor memory is mounted to the drive as appropriate, so that a computer program read out of the medium is installed to the storage unit 513 as needed.

When the aforementioned series of processes is executed by the software, the program configuring the software is installed from the network or a recording medium.

As illustrated in an example in FIG. 21, for example, the recording medium is configured by the removable medium 521 including the magnetic disk (including a flexible disk), the optical disk (including a CD-ROM (Compact Disc-Read Only Memory) and a DVD (Digital Versatile Disc)), the magneto-optical disk (including an MD (Mini Disc)), or the semiconductor memory in which a program is recorded and which is distributed, to deliver the program to a user separately from the device itself; the ROM 502 in which the program is recorded and which is delivered to a user while being incorporated in the device itself in advance; and the hard disk included in the storage unit 513.

Note that the program executed by the computer may be a program performing a process in time series along the order described herein, or a program performing a process in parallel or at a required timing when called, for example.

Furthermore, a step of describing the program recorded in the recording medium herein includes not only a process performed in time series along the order described but also a process that is performed in parallel or individually.

A system herein represents the whole device including a plurality of devices.

The configuration described as one device (or processing unit) above may be divided into a plurality of devices (or processing units). To the contrary, the configuration described as the plurality of devices (or processing units) above may be integrated into one device (or processing unit). Moreover, a configuration other than the aforementioned configuration may certainly be added to the configuration of each device (or processing unit). Furthermore, a part of the configuration of some device (or processing unit) may be included in the configuration of another device (or another processing unit) as long as the system-wide configuration and operation are substantially the same. That is, the present technique is not limited to the aforementioned embodiments but can take various changes without departing from the scope of the present technique.

The image encoding device and the image decoding device according to the aforementioned embodiments can be applied to various electronic devices including: a transmitter or a receiver used in cable broadcasting such as the satellite broadcasting and cable TV, distribution on the Internet, or distribution to a terminal in cellular communication; a recording device which records an image into a medium such as the optical disk, the magnetic disk or a flash memory; and a reproduction device which reproduces the image from these storage media. Four application examples will be described below.

### 4. Fourth Embodiment

### First Application Example: Television Set

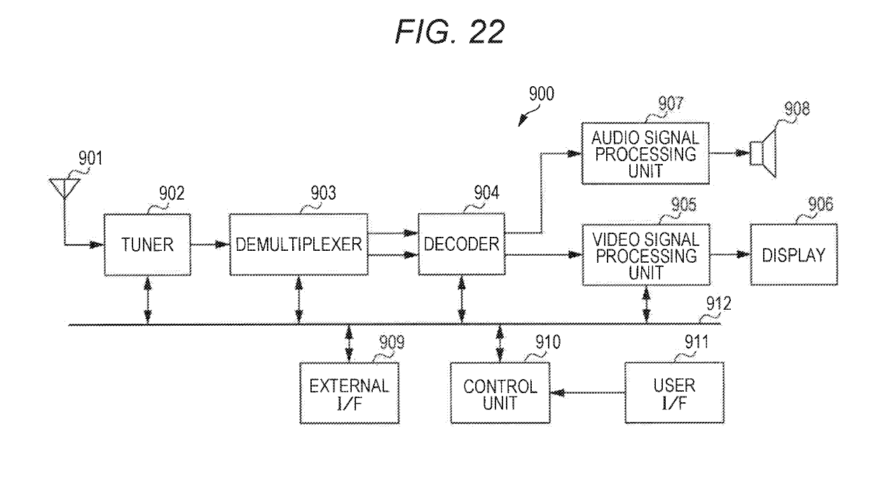

FIG. 22 is a diagram illustrating an example of a schematic configuration of a television device applying the aforementioned embodiment. A television device 900 includes an antenna 901, a tuner 902, a demultiplexer 903, a decoder 904, a video signal processing unit 905, a display 906, an audio signal processing unit 907, a speaker 908, an external interface 909, a control unit 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as transmission means receiving the encoded stream in which an image is encoded, in the television device 900.

The demultiplexer 903 isolates a video stream and an audio stream in a program to be viewed from the encoded bit stream and outputs each of the isolated streams to the decoder 904. The demultiplexer 903 also extracts auxiliary data such as an EPG (Electronic Program Guide) from the encoded bit stream and supplies the extracted data to the control unit 910. Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing unit 905. Furthermore, the decoder 904 outputs audio data generated by the decoding process to the audio signal processing unit 907.

The video signal processing unit 905 reproduces the video data input from the decoder 904 and displays the video on the display 906. The video signal processing unit 905 may also display an application screen supplied through the network on the display 906. The video signal processing unit 905 may further perform an additional process such as noise reduction on the video data according to the setting. Furthermore, the video signal processing unit 905 may generate an image of a GUI (Graphical User Interface) such as a menu, a button, or a cursor and superpose the generated image onto the output image.

The display 906 is driven by a drive signal supplied from the video signal processing unit 905 and displays video or an image on a video screen of a display device (such as a liquid crystal display, a plasma display, or an OELD (Organic ElectroLuminescence Display)).

The audio signal processing unit 907 performs a reproducing process such as D/A conversion and amplification on the audio data input from the decoder 904 and outputs the audio from the speaker 908. The audio signal processing unit 907 may also perform an additional process such as noise reduction on the audio data.

The external interface 909 is an interface that connects the television device 900 with an external device or a network. For example, the decoder 904 may decode a video stream or an audio stream received through the external interface 909. This means that the external interface 909 also has a role as the transmission means receiving the encoded stream in which an image is encoded, in the television device 900.

The control unit 910 includes a processor such as a CPU and a memory such as a RAM and a ROM. The memory stores a program executed by the CPU, program data, EPG data, and data acquired through the network. The program stored in the memory is read by the CPU at the start-up of the television device 900 and executed, for example. By executing the program, the CPU controls the operation of the television device 900 in accordance with an operation signal that is input from the user interface 911, for example.

The user interface 911 is connected to the control unit 910. The user interface 911 includes a button and a switch for a user to operate the television device 900 as well as a reception part which receives a remote control signal, for example. The user interface 911 detects a user operation through these components, generates the operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

The decoder 904 in the television device 900 configured in the aforementioned manner has a function of the image decoding device according to the aforementioned embodiment. As a result, the efficiency of encoding the motion vector can be improved by using, as the temporal predictive motion vector information, the motion vector information that has high correlation with the motion vector information of the current region in decoding an image in the television device 900.

### 5. Fifth Embodiment

### Second Application Example: Mobile Telephone

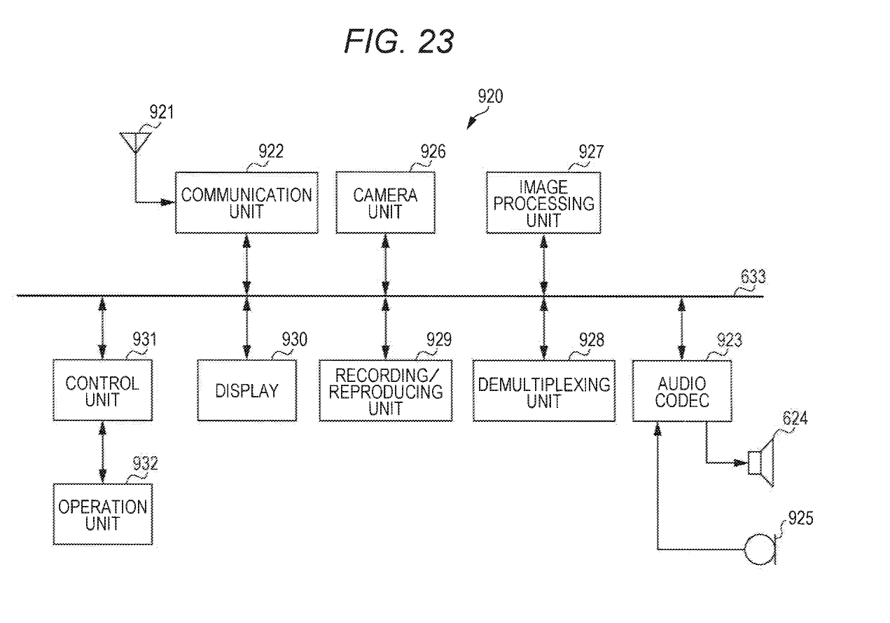

FIG. 23 is a diagram illustrating an example of a schematic configuration of a mobile telephone applying the aforementioned embodiment. A mobile telephone 920 includes an antenna 921, a communication unit 922, an audio codec 923, a speaker 924, a microphone 925, a camera unit 926, an image processing unit 927, a demultiplexing unit 928, a recording/reproducing unit 929, a display 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the demultiplexing unit 928, the recording/reproducing unit 929, the display 930, and the control unit 931.

The mobile telephone 920 performs an operation such as transmitting/receiving an audio signal, transmitting/receiving an electronic mail or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923.

The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of the recording/reproducing unit 929.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the storing/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then outputs the audio by supplying the generated audio signal to the speaker 924.

The image processing unit 927 in the mobile telephone 920 configured in the aforementioned manner has a function of the image encoding device and the image decoding device according to the aforementioned embodiment. As a result, the efficiency of encoding the motion vector can be improved by using, as the temporal predictive motion vector information, the motion vector information that has high correlation with the motion vector information of the current region in encoding and decoding an image in the mobile telephone 920.

### 6. Sixth Embodiment

### Third Application Example: Recording/Reproducing Device

FIG. 24 is a diagram illustrating an example of a schematic configuration of a recording/reproducing device applying the aforementioned embodiment. A recording/reproducing device 940 encodes audio data and video data of a broadcast program received and records the data into a recording medium, for example. The recording/reproducing device 940 may also encode audio data and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USE interface, or a flash memory interface. The video data and the audio data received through the external interface 942 are input to the encoder 943, for example. That is, the external interface 942 has a role as transmission means in the recording/reproducing device 940.

The encoder 943 encodes the video data and the audio data when the video data and the audio data input from the external interface 942 are not encoded. The encoder 943 thereafter outputs an encoded hit stream to the selector 946.

The HDD 944 records, into an internal hard disk, the encoded hit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded hit stream to the HDD 944 or the disk drive 945. When reproducing the video and audio, on the other hand, the selector 946 outputs the encoded hit stream input from the HDD 944 or the disk drive 945 to the decoder 947.

The decoder 947 decodes the encoded bit stream to generate the video data and the audio data. The decoder 947 then outputs the generated video data to the OSD 948. The decoder 904 outputs the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a CPU and a memory such as a RAM and a ROM. The memory stores a program executed by the CPU as well as program data. The program stored in the memory is read by the CPU at the start-up of the recording/reproducing device 940 and executed, for example. By executing the program, the CPU controls the operation of the recording/reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

The encoder 943 in the recording/reproducing device 940 configured in the aforementioned manner has a function of the image encoding device according to the aforementioned embodiment. On the other hand, the decoder 947 has a function of the image decoding device according to the aforementioned embodiment. As a result, the efficiency of encoding the motion vector can be improved by using, as the temporal predictive motion vector information, the motion vector information that has high correlation with the motion vector information of the current region in encoding and decoding an image in the recording/reproducing device 940.

### 7, Seventh Embodiment

### Fourth Application Example: Imaging Device

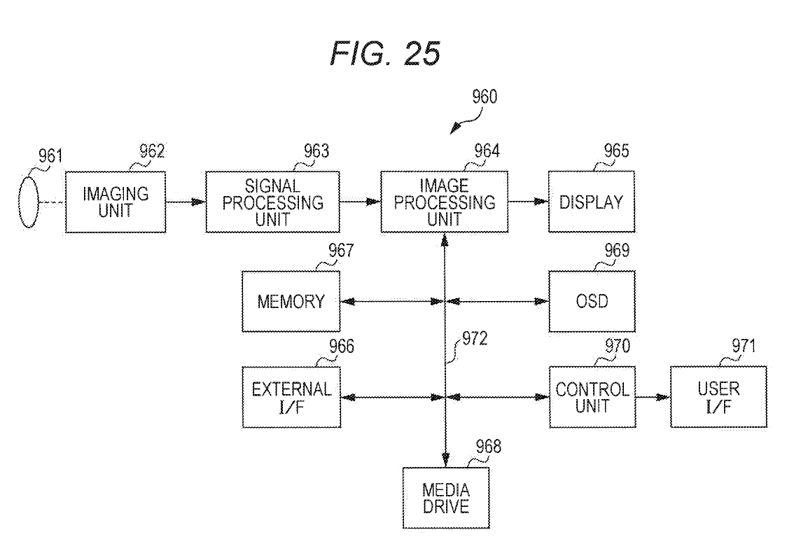

FIG. 25 is a diagram illustrating an example of a schematic configuration of an imaging device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of the object on an imaging surface of the imaging unit 962. The imaging unit 962 includes an image sensor such as a COD (Charge Coupled Device) or a CMOS (Complementary Metal Oxide Semiconductor) and performs photoelectric conversion to convert the optical image formed on the imaging surface into an image signal as an electric signal. Subsequently, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964,

The external interface 966 is configured as a USB input/output terminal, for example. The external interface 966 connects the imaging device 960 with a printer when printing an image, for example. Moreover, a drive is connected to the external interface 966 as needed. A removable medium such as a magnetic disk or an optical disk is mounted to the drive, for example, so that, a program read from the removable medium can be installed to the imaging device 960. The external interface 966 may also be configured as a network interface that is connected to a network such as a LAN or the Internet. That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mounted to the media drive 968 so that a non-transportable storage unit such as a built-in hard disk drive or an SSD (Solid State Drive) is configured, for example.

The control unit 970 includes a processor such as a CPU and a memory such as a RAM and a ROM. The memory stores a program executed by the CPU as well as program data. The program stored in the memory is read by the CPU at the start-up of the imaging device 960 and then executed. By executing the program, the CPU controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The image processing unit 964 in the imaging device 960 configured in the aforementioned manner has a function of the image encoding device and the image decoding device according to the aforementioned embodiment. As a result, the efficiency of encoding the motion vector can be improved by using, as the temporal predictive motion vector information, the motion vector information that has high correlation with the motion vector information of the current region in encoding and decoding an image in the imaging device 960.

Described herein is the example where various pieces of information such as the predictive motion vector information and the differential motion information is multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the information may be transmitted on a different transmission path from the image (or the bit stream). The information may also be recorded in a different recording medium (or a different recording area in the same recording medium) from the image (or the bit stream). Furthermore, the information and the image (or the bit stream) may be associated with each other by an arbitrary unit such as a plurality of frames, one frame, or a portion within a frame.

While the preferred embodiments of the present technique have been described in detail with reference to the attached drawings, the present technique is not to be limited to such examples. It is apparent that those having ordinary skill in the art to which the present technique pertains can make various changes or modifications within the scope of the technical idea described in claims, whereby it is to be understood that these changes or modifications certainly pertain to the technical scope of the present technique.

Note that the present technique can also take the following configurations.

(1)

An image processing apparatus including:

a determination unit which determines, in performing motion prediction on an image, an extraction region from which motion vector information is extracted as temporal predictive motion vector information from within a reference region in a reference image, the reference region corresponding to a current region to be processed; and

a difference generation unit which generates differential motion information that is a difference between the temporal predictive motion vector information extracted from the extraction region determined by the determination unit and motion information of the current region, wherein

the reference region is partitioned into a plurality of divided regions, and

the determination unit determines a largest region having the largest area of overlap with the current region as the extraction region from among the plurality of divided regions within the reference region.

(2)

The image processing apparatus according to (1), wherein the determination unit has a rule of determining, when there is a plurality of the largest regions, the extraction region from among the plurality of largest regions.

(3)

The image processing apparatus according to (1) or (2), wherein the rule determines the largest region appearing first when the reference region is traced in a raster scan order to be the extraction region.

(4)

The image processing apparatus according to (1), (2) or (3), wherein the rule determines the largest region encoded by inter prediction and appearing first when the reference region is traced in a raster scan order to be the extraction region.

(5)

The image processing apparatus according to any of (1) to (4), wherein

the reference region is partitioned into the plurality of divided regions, and

the determination unit determines:
the largest region having the largest area of overlap with the current region among the plurality of divided regions within the reference region to be the extraction region when a size of the current region is equal to or larger than a predetermined threshold; and
a divided region including a pixel having the same address as a pixel in an upper left part of the current region among the plurality of divided regions within the reference region to be the extraction region when a size of the current region is smaller than the predetermined threshold.
   (6)

The image processing apparatus according to any of (1) to (5), wherein the predetermined threshold is specified in a sequence parameter set, a picture parameter set, or a slice header included in image compression information to be an input.

(7)

The image processing apparatus according to any of (1) to (6), wherein

the determination unit determines:
the largest region having the largest area of overlap with the current region among the plurality of divided regions within the reference region to be the extraction region when a profile level in image compression information to be an output is equal to or higher than a predetermined threshold; and
a divided region including a pixel having the same address as a pixel in an upper left part of the current region among the plurality of divided regions within the reference region to be the extraction region when the profile level in the image compression information to be the output is lower than the predetermined threshold.
   (8)

The image processing apparatus according to any of (1) to (7), wherein the profile level is a picture frame.

(9)

An image processing method including:

a determination step of determining, in performing motion prediction on an image, an extraction region from which motion vector information is extracted as temporal predictive motion vector information from within a reference region in a reference image, the reference region corresponding to a current region to be processed; and

a difference generation step of generating differential motion information that is a difference between the temporal predictive motion vector information extracted from the extraction region determined by a process performed in the determination step and motion information of the current region, wherein

the reference region is partitioned into a plurality of divided regions, and

the determination step determines the largest region having the largest area of overlap with the current region as the extraction region from among the plurality of divided regions within the reference region.

(10)

An image processing apparatus including

an acquisition unit which acquires, in decoding encoded data of an image, differential motion information that is a difference between temporal predictive motion vector information used in encoding the image and motion information of a current region to be processed;

a determination unit which determines an extraction region from which motion vector information is extracted as the temporal predictive motion vector information from within a reference region in a reference image, the reference region corresponding to the current region; and

a motion information reconstruction part which reconstructs motion information of the current region provided for motion compensation by using the differential motion information acquired by the acquisition unit and the temporal predictive motion vector information extracted from the extraction region that is determined by the determination unit, wherein

the reference region is partitioned into a plurality of divided regions, and

the determination unit determines the largest region having the largest area of overlap with the current region as the extraction region from among the plurality of divided regions within the reference region.

(11)

The image processing apparatus according to (10), wherein the determination unit has a rule of determining, when there is a plurality of the largest regions, the extraction region from among the plurality of largest regions.

(12)

The image processing apparatus according to (10) or (11), wherein the rule determines the largest region appearing first when the reference region is traced in a raster scan order to be the extraction region.

(13)

The image processing apparatus according to (10), (11) or (12), wherein the rule determines the largest region encoded by inter prediction and appearing first when the reference region is traced in a raster scan order to be the extraction region.

(14)

The image processing apparatus according to any of (10) to (13), wherein

the reference region is partitioned into the plurality of divided regions, and

the determination unit determines:
the largest region having the largest area of overlap with the current region among the plurality of divided regions within the reference region to be the extraction region when a size of the current region is equal to or larger than a predetermined threshold; and
a divided region including a pixel having the same address as a pixel in an upper left part of the current region among the plurality of divided regions within the reference region to be the extraction region when a size of the current region is smaller than the predetermined threshold.
   (15)

The image processing apparatus according to any of (10) to (14), wherein the predetermined threshold is specified in a sequence parameter set, a picture parameter set, or a slice header included in image compression information to be an input.

(16)

16. The image processing apparatus according to any of (10) to (15), wherein

the determination unit determines:
the largest region having the largest area of overlap with the current region among the plurality of divided regions within the reference region to be the extraction region when a profile level in image compression information to be an output is equal to or higher than a predetermined threshold; and
a divided region including a pixel having the same address as a pixel in an upper left part of the current region among the plurality of divided regions within the reference region to be the extraction region when the profile level in the image compression information to be the output is lower than the predetermined threshold.
   (17)

The image processing apparatus according to any of (10) to (16), wherein the profile level is a picture frame.

(18)

An image processing method including:

an acquisition step of acquiring, in decoding encoded data of an image, differential motion information that is a difference between temporal predictive motion vector information used in encoding the image and motion information of a current region to be processed;

a determination step of determining an extraction region from which motion vector information is extracted as the temporal predictive motion vector information from within a reference region in a reference image, the reference region corresponding to the current region; and

a motion information reconstruction step of reconstructing motion information of the current region provided for motion compensation by using the differential motion information acquired by the process performed in the acquisition step and the temporal predictive motion vector information extracted from the extraction region that is determined by the process performed in the determination step, wherein

the reference region is partitioned into a plurality of divided regions, and

the process performed in the determination step determines the largest region having the largest area of overlap with the current region as the extraction region from among the plurality of divided regions within the reference region.

### REFERENCE SIGNS LIST

100 image encoding device, 115 motion prediction/compensation unit, 121 temporal predictive motion vector information determination unit, 122 motion vector encoding unit, 141 spatial predictive motion vector information determination part, 142 predictive motion vector information generation part, 143 differential motion vector generation part, 200 image decoding device, 212 motion prediction/compensation unit, 221 temporal predictive motion vector information determination unit, 222 motion vector decoding unit, 241 temporal predictive motion vector information reconstruction part, 242 predictive motion vector information reconstruction part, 243 spatial predictive motion vector information reconstruction part

1. An image processing apparatus comprising:
a determination unit which determines, in performing motion prediction on an image, an extraction region from which motion vector information is extracted as temporal predictive motion vector information from within a reference region in a reference image, the reference region corresponding to a current region to be processed; and
a difference generation unit which generates differential motion information that is a difference between the temporal predictive motion vector information extracted from the extraction region determined by the determination unit and motion information of the current region, wherein
the reference region is partitioned into a plurality of divided regions, and
the determination unit determines a largest region having the largest area of overlap with the current region as the extraction region from among the plurality of divided regions within the reference region.

2. The image processing apparatus according to claim 1, wherein the determination unit has a rule of determining, when there is a plurality of the largest regions, the extraction region from among the plurality of largest regions.

3. The image, processing apparatus according to claim 2, wherein the rule determines the largest region appearing first when the reference region is traced in a raster scan order to be the extraction region.

4. The image processing apparatus according to claim 2, wherein the rule determines the largest region encoded by inter prediction and appearing first when the reference region is traced in a raster scan order to be the extraction region.

5. The image processing apparatus according to claim 1, wherein
the reference region is partitioned into the plurality of divided regions, and
the determination unit determines:
the largest region having the largest area of overlap with the current region among the plurality of divided regions within the reference region to be the extraction region when a size of the current region is equal to or larger than a predetermined threshold; and
a divided region including a pixel having the same address as a pixel in an upper left part of the current region among the plurality of divided regions within the reference region to be the extraction region when a size of the current region is smaller than the predetermined threshold.

6. The image processing apparatus according to claim 5, wherein the predetermined threshold is specified in a sequence parameter set, a picture parameter set, or a slice header included in image compression information to be an input.

7. The image processing apparatus according to claim 1, wherein
the determination unit determines:
the largest region having the largest area of overlap with the current region among the plurality of divided regions within the reference region to be the extraction region when a profile level in image compression information to be an output is equal to or higher than a predetermined threshold; and
a divided region including a pixel having the same address as a pixel in an upper left part of the current region among the plurality of divided regions within the reference region to be the extraction region when the profile level in the image compression information to be the output is lower than the predetermined threshold.

8. The image processing apparatus according to claim 7, wherein the profile level is a picture frame.

9. An image processing method comprising:
a determination step of determining, in performing motion prediction on an image, an extraction region from which motion vector information is extracted as temporal predictive motion vector information from within a reference region in a reference image, the reference region corresponding to a current region to be processed; and
a difference generation step of generating differential motion information that is a difference between the temporal predictive motion vector information extracted from the extraction region determined by a process performed in the determination step and motion information of the current region, wherein
the reference region is partitioned into a plurality of divided regions, and
the determination step determines the largest region having the largest area of overlap with the current region as the extraction region from among the plurality of divided regions within the reference region.

10. An image processing apparatus comprising:
an acquisition unit which acquires, in decoding encoded data of an image, differential motion information that is a difference between temporal predictive motion vector information used in encoding the image and motion information of a current region to be processed;
a determination unit which determines an extraction region from which motion vector information is extracted as the temporal predictive motion vector information from within a reference region in a reference image, the reference region corresponding to the current region; and
a motion information reconstruction part which reconstructs motion information of the current region provided for motion compensation by using the differential motion information acquired by the acquisition unit and the temporal predictive motion vector information extracted from the extraction region that is determined by the determination unit, wherein
the reference region is partitioned into a plurality of divided regions, and
the determination unit determines the largest region having the largest area of overlap with the current region as the extraction region from among the plurality of divided regions within the reference region.

11. The image processing apparatus according to claim 10, wherein the determination unit has a rule of determining, when there is a plurality of the largest regions, the extraction region from among the plurality of largest regions.

12. The image processing apparatus according to claim 11, wherein the rule determines the largest region appearing first when the reference region is traced in a raster scan order to be the extraction region.

13. The image processing apparatus according to claim 11, wherein the rule determines the largest region encoded by inter prediction and appearing first when the reference region is traced in a raster scan order to be the extraction region.

14. The image processing apparatus according to claim 10, wherein
the reference region is partitioned into the plurality of divided regions, and
the determination unit determines:
the largest region having the largest area of overlap with the current region among the plurality of divided regions within the reference region to be the extraction region when a size of the current region is equal to or larger than a predetermined threshold; and
a divided region including a pixel having the same address as a pixel in an upper left part of the current region among the plurality of divided regions within the reference region to be the extraction region when a size of the current region is smaller than the predetermined threshold.

15. The image processing apparatus according to claim 14, wherein the predetermined threshold is specified in a sequence parameter set, a picture parameter set, or a slice header included in image compression information to be an input.

16. The image processing apparatus according to claim 10, wherein
the determination unit determines:
the largest region having the largest area of overlap with the current region among the plurality of divided regions within the reference region to be the extraction region when a profile level in image compression information to be an output is equal to or higher than a predetermined threshold; and
a divided region including a pixel having the same address as a pixel in an upper left part of the current region among the plurality of divided regions within the reference region to be the extraction region when the profile level in the image compression information to be the output is lower than the predetermined threshold.

17. The image processing apparatus according to claim 16, wherein the profile level is a picture frame.

18. An image processing method comprising:
an acquisition step of acquiring, in decoding encoded data of an image, differential motion information that is a difference between temporal predictive motion vector information used in encoding the image and motion information of a current region to be processed;
a determination step of determining an extraction region from which motion vector information is extracted as the temporal predictive motion vector information from within a reference region in a reference image, the reference region corresponding to the current region; and
a motion information reconstruction step of reconstructing motion information of the current region provided for motion compensation by using the differential motion information acquired by the process performed in the acquisition step and the temporal predictive motion vector information extracted from the extraction region that is determined by the process performed in the determination step, wherein
the reference region is partitioned into a plurality of divided regions, and
the process performed in the determination step determines the largest region having the largest area of overlap with the current region as the extraction region from among the plurality of divided regions within the reference region.
